(19) United States
(12) Patent Application Publication
(10) Pub. No.: US 2005/0213919 A1
(43) Pub. Date: Sep. 29, 2005

(54) HOLDING EQUIPMENT FOR OPTICAL FIBER

(76) Inventor: Sadao Minegishi, TOCHIGI-SHI, TOCHIGI (JP)

Correspondence Address: SMITH PATENT OFFICE, 1901 PENNSYLVANIA AVENUE N W, SUITE 200, WASHINGTON, DC, 20006, US

(21) Appl. No.: 10/493,657

(22) PCT Filed: Oct. 28, 2002
(86) PCT No.: PCT/JP02/11134

§ 371 Date: Apr. 28, 2005

(30) Foreign Application Priority Data
Oct. 26, 2001 (JP) 2001-365348

(51) Int. Cl. G02B 6/00

(52) U.S. Cl. 385/135

(57) ABSTRACT

In the conventional process of the handling of the relatively short optical fiber, the optical fiber is wound into a coreless loop and is tied up by using spiral tubes or is fixed by adhesive tape, to attach ferule to the terminal of the fiber, to form antireflective layer, to deliver. However, due to hardness and weakness against bending, the optical fiber have to be corrected the holding according to work respectively, in addition, there are problem such that the optical fiber is unwound and snapped. The present invention solved such problem by providing compact holding equipment for optical fiber comprising at least one optical fiber holding area which comprises core of reel, side walls connected with the core of reel and elastic projections formed on at least one of the side wall, made of, for example, fluororubber.

### TECHNICAL FIELD

The present invention relates to holding equipment for optical fiber to hold relatively short length optical fiber (hereinafter, to also simply be referred to as fiber) having length less than several tens meters, for example, such as 2 m or 5 m.

### BACKGROUND ART

In an optical communication field, relatively short length optical fiber having length less than several tens meters, for example such as 2 m or 5 m, is used in addition to long optical fiber being used for optical communication path. Such short length optical fiber is used with collimator for a device such as isolator, WDM and so on, that is attached to the end portion of the fiber.

It is needed for such optical fiber in its manufacturing process that many kinds of processing, for example, such as attaching collimator to the terminal of the fiber, attaching ferule to the terminal of the fiber, polishing of the terminal surface of the fiber, forming antireflective layer on the terminal surface of the fiber in a vaporized deposition system, have to be done after cutting the fiber to length of, for example, 2 m or 3 m.

In the conventional process, the handling of the optical fiber in the above-mentioned process or delivery is performed in such way in which the optical fiber is wound into a coreless loop and is tied up by using spiral tubes or is fixed by adhesive tape, and then, in a case wherein collimator or ferule is attached to the terminal of the fiber, or in a case wherein the terminal surface of the fiber is polished and so forth, the work is done by unwinding necessary part of the fiber which is the vicinity of the end portion of the fiber, and in a case of delivery, the coreless-loop-styled fiber is delivered by being fixed on a small plastic plate using vinyl tape and put it into a case. When antireflective layer is formed on the terminal surface of the optical fiber using a vacuum vaporized deposition device, the temperature around the fiber goes up beyond 100° C., therefore it is not favorable to use the spiral tubes or adhesive tape, and the components which hold the optical fiber should be removed and instead of that components for vacuum should be used to hold the optical fiber because all components to fix or hold the optical fiber should be components which do not gas in above-mentioned environment and do not harm to antireflective layer in its quality due to the gas.

FIG. 30 and FIG. 31 are drawings that explain the conventional handling method of such short optical fiber. FIG. 31 is drawing that explains the handling method for the optical fiber in a case wherein collimator or ferule is attached to the short optical fiber or in a case wherein the terminal surface of the optical fiber is polished.

In FIG. 31, reference symbol 101 indicates a fiber wound into loop having length of, for example, 2.2 m, reference symbol 102 indicates a collimator attached to the terminal portion of one side of optical fiber 101, reference symbol 103 indicates a ferule attached to the terminal portion of the other side of optical fiber 101, reference symbols 121 and 122 indicate, for example, spiral tubes to prevent optical fiber 101 from untying being wound into a coreless loop.

In the conventional process, the optical fiber was wound into a loop as shown in FIG. 31, and a part of the optical fiber being necessary length was drew out from the loop, then some kind of the process such as that attaching the collimator to the optical fiber, attaching the ferule to the optical fiber, or polishing the terminal surface of the optical fiber are proceeded.

FIG. 30 is drawing that explains the handling method of processed optical fiber in case of transporting or delivering. In FIG. 30, reference symbols 105˜109 indicate adhesive tape to fix optical fiber 101 wound to a coreless loop having a collimator 102 attached to the terminal portion of one side of the optical fiber and a ferule 103 attached to the terminal portion of the other side of the optical fiber. The completed optical fiber is transported or delivered by fixing on the plate 110 as shown in FIG. 30 and putting it into a case (not shown in the drawing).

As was previously known, optical fiber is weak against bending, moreover, it is hard, therefore, in a case wherein the fiber wound into a coreless loop as shown in FIG. 31 is handled, when the fiber is drew out from the loop, it is necessary to prevent snapping of the fiber due to that diameter of the loop, especially partial diameter, becomes too small, and in addition, it is dangerous to draw out the fiber from the loop as being tied by the spiral tubes, consequently, it spends long futile time for preparing process to manufacture the terminal portion of the fiber, for example, to draw out the fiber till necessary length of it while the spiral tube is shifted by inches as paying attention to keep the loop having the required shape, furthermore, it brings increase of additional implements and processes for manufacturing the fiber, thus, the conventional process has problem that cost of manufacturing goes up.

Furthermore, in the process of the terminal portion of the fiber, yield of process is apt to become lower because of loosing of the loop, difficulty of drawing out the fiber to constant length, snapping of the fiber by bending stress in the process.

In order to solve such problems, a winding method to wind the optical fiber to a reel like a spool and a winding method using a reel which has side wall or ditch are presented, but, owing to its bad points which are not only that the diameter of the reel must be large due to hardness of the fiber but also that processing time becomes long due to, for example, the fiber wound to the reel is apt to unwind, and owing to its bad point which is that accuracy of processing is low, they could not be used.

In order to attempt improving the accuracy of processing and reduction of cost, automated process in which fiber is cut to such short length of 2 m, 3 m etc. from fiber of one bundle of 10 km wound on a reel and each of the fibers is processed to easy to handle style is not provided at all.

And, in a case wherein antireflective layer is formed on the terminal surface of the optical fiber, when gas come out from components which hold the optical fiber, strength of the antireflective layer is weaken and a satisfactory antireflective layer can not be formed, consequently, components for vacuum is used. Furthermore, because in a case of the conventional holding method for the optical fiber, it can not hold the optical fiber into stable and compact style, consequently, it is impossible to form high quality antireflective layer having almost equal characteristics on the terminal surface of the fiber of a large number of optical fibers at one time.

In case of transportation or delivery, there are also problems of a large case and expensive cost, and at the receiver side of the delivered fiber there are also similar problems of handling.

As was previously known, in a case of relatively short length optical fibers being used in the optical communication having length less than several tens meters such as 2 m or 5 m, there are several different type, for example, so-called buffered fiber having diameter of 0.25 mm, so-called core fiber having diameter of 0.9 mm, a fiber, hereinafter, to be referred to as 2-ribbon fiber which is packaged two buffered fibers putting them side by side and covered with resin in tape state, a fiber, hereinafter, to be referred to as 4-ribbon fiber which is packaged four buffered fibers putting them side by side and covered with resin in tape state, a fiber, hereinafter, to be referred to as 8-ribbon fiber which is packaged eight buffered fibers putting them side by side and covered with resin in tape state, a fiber, hereinafter, to be referred to as 12-ribbon fiber which is packaged twelve buffered fibers putting them side by side and covered with resin in tape state, and so on. Aforementioned each ribbon fiber is that, for example, thickness of every ribbon fiber is 0.3 mm, width of 4-ribbon fiber is 1˜1.1 mm, width of 8-ribbon fiber is 2˜2.2 mm.

Aforementioned problems of holding optical fiber which is relatively short optical fiber having length less than several tens meters, for example, such as 2 m or 5 m, in a case of processing or delivery, are also big problems for each case of buffered fiber, core fiber, and ribbon fiber, and, for example, in a case of ribbon fiber, that are serious problems.

In consideration of these problems, a purpose of the present invention is to provide such holding equipment for the optical fiber that snapping or jumbling of the fiber in handling for processing dose not occur, preparing process to manufacture and manufacturing itself are easy, automated process is available, fiber is not unwound automatically when the fiber is held by the holding equipment having diameter less than, for example, 10 cm without aforementioned special treatment to hold the fiber cut to required length by using spiral tubes or to paste the fiber by adhesive tape and the fiber held by the holding equipment is placed on the working table, and in a case of transportation or delivery, conventional large and expensive case is not necessary, and to provide such holding equipment for the optical fiber that it is possible to hold the fiber in compact and it is inexpensive. In addition, another purpose of the present invention is to provide inexpensively such holding equipment for optical fiber that, as aforementioned, handling in process and delivery is easy, and moreover, there is no problem in out-gassing when antireflective layer is formed on the terminal surface of the optical fiber using a vacuum vaporized deposition device, even if the same holding equipment is put in the vacuum vaporized deposition device as is.

### DISCLOSURE OF INVENTION

The present invention was performed to achieve above-mentioned purpose.

The present invention has many kind of characteristics, one of the major characteristics is that the holding equipment for the optical fiber comprises at least one pair of side walls which are placed in opposition each other and constitute holding unit for the optical fiber, and comprises elastic projections on at least one said side wall, and the holding equipment for the optical fiber is capable to hold many kind of optical fiber, given the details later, by constituting the projections appropriately.

Moreover, another major characteristics of the present invention is to provide such holding equipment for optical fiber that it is compact and inexpensive holding equipment and it can be used in a vacuum vaporized deposition device by forming the projections using fluorocarbon elastomers for material of the projections, for example, forming the whole holding equipment by one-piece molding technology using fluorocarbon elastomer.

To achieve the purpose of the present invention, many kinds of modes having the following characteristics are available for the present invention. Followings are characteristics of examples of the modes of the present invention.

The present invention relates to holding equipment for optical fiber, and the holding equipment for optical fiber of the present invention is characterized by being able to put optical fiber in it and to hold optical fiber in it, and comprising at least one holding unit for optical fiber comprising at least one pair of side walls which are placed in opposition each other and plural elastic projections placed on at least one said side wall.

An example of holding equipment for optical fiber of the present invention is characterized by that at least one said holding unit for optical fiber comprises core of reel wherein optical fiber can be wound on it, said core of reel is placed by connecting with said side wall or closing to said side wall, said projections placed on at least one said side wall of holding unit are placed at plural locations of said side wall that is positions, hereinafter, to be also referred to as the inner part of side wall, namely, positions which are inner side from a fringe of the side wall of holding unit, that is, closer positions to said core of reel on the side wall, and said projections are formed as elastic projections which stick out from one side wall toward the opposite side wall, and by that at least said one pair of side walls, said elastic projections and said core of reel construct optical fiber holding area in which optical fiber can be held.

In an example of holding equipment for optical fiber of the present invention, though, for the shape of fringe of said core of reel on which optical fiber can be wound, many kind of shape are available and for the shape of fringe of said core of reel, especially circular shape, ellipsoidal shape, and polygonal shape are desirable, and also, for the shape of said side wall of at least one said holding unit for optical fiber, many kind of shape are available and for the shape of major part of at least one of said side wall, especially flat board state is desirable, and for the shape of fringe of said side wall, especially circular shape, ellipsoidal shape, and polygonal shape are desirable.

An example of holding equipment for optical fiber of the present invention is characterized by that at least one said side wall, plural projections placed on the wall and core of reel connected to the wall are formed into one-piece.

An example of holding equipment for optical fiber of the present invention is characterized by that plural of said projections have such shape that the shape is shape, hereinafter, to be referred to as slender shape, for example, shape like a pole, flat shape, and have such measure that length of the projection sticking out from the side wall on which the projection is formed is longer than the maximum measure of cross section of the projection, defining the cross section of the projection is that crossing at right angles to the center line of length direction of the projection and the measure of the cross section is measured as a straight line from one end to the opposite end through the center of the cross section.

An example of holding equipment having said slender shape projections for optical fiber of the present invention is characterized by that each of plural of said elastic projections is formed slanted such that a length directional mean central axis of said projection which is a imaginary axis, hereinafter, to be referred to as a length directional center line, slants toward inner side of the optical fiber holding area as making required angle θ1 with the perpendicular line of said side wall at the place, and especially it is desirable that all the projections formed for at least one said holding unit are formed slanted such that each length directional center line slants toward inner side of the optical fiber holding area as making required angle θ1 to the perpendicular line of said side wall at the place. And when the angle θ1 is smaller than 10 degree, an example of holding equipment for optical fiber of the present invention shows noticeable effect.

An example of holding equipment for optical fiber of the present invention is characterized by that said projection which is placed on the side wall of at least one holding unit is formed slanted such that a length directional center line slants toward one direction along the fringe of the side wall as making required angle θ3, and especially it is desirable that all the projections formed on the side wall of at least one holding unit are formed slanted such that each length directional center line of it slants toward one direction along the fringe of the side wall as making required angle θ3. When said required angle θ3 is smaller than 10 degree, an example of holding equipment for optical fiber of the present invention shows noticeable effect.

An example of holding equipment for optical fiber of the present invention is characterized by that each of said plural projections is that outside tangent of outline of the projection of radius direction of the side wall on which the projection is placed and inside tangent of outline of the projection of radius direction of the side wall crosses as making required angle θ2 on the cross section which include the center point of the side wall on which the projection is placed, the center point of the root of the projection and the end point of the center line of the projection, except parts having large alteration for example root around and the end point around of the projection, and the projection is dwindling from root of it to the end point of it, and especially it is desirable that each of all the projections of at least one said holding unit is that outside tangent of outline of the projection of radius direction of the side wall on which the projection is placed and inside tangent of outline of the projection of radius direction of the side wall crosses as making required angle θ2 on the cross section which include the center point of the side wall on which the projection is placed, the center of the root of the projection and the tip of the center line of the projection, except parts having large alteration for example root around and the end point around of the projection. When the required angle θ2 is smaller than 15 degree, an example of holding equipment for optical fiber of the present invention shows noticeable effect.

An example of holding equipment for optical fiber of the present invention is characterized by that dimension of the cross section of said elastic projection of at least one holding unit is such that a mean diameter of the projection at the middle part in length direction is 0.4˜2 mm, and especially it is desirable that each of all said elastic projections of at least one holding unit is that dimension of the cross section of said elastic projection is such that a mean diameter of the projection at the middle in length direction is 0.4˜2 mm.

An example of holding equipment for optical fiber of the present invention is characterized by that shape of the tip of said elastic projection is a part of circle having diameter of 0.2˜1 mm on the cross section of the projection including the center of the side wall on which the projection is placed.

An example of holding equipment for optical fiber of the present invention is characterized by that said projection is such projection that diameter of the tip around is smaller than diameter of the root around.

For an example of holding equipment for optical fiber of the present invention, from such point of view as easy to handle and realizing high reliability it is desirable that length of at least one said elastic projection is longer than one fourth of space between a pair of side walls which are placed in opposition each other, and suitable length of the projection is depend on a form of the optical fiber.

An example of holding equipment for optical fiber of the present invention is characterized by that length of at least one said elastic projection is longer than one half of space between a pair of said side walls which are placed in opposition each other.

For an example of holding equipment for optical fiber of the present invention, it is desirable that in case where the holding equipment is used for the buffered fiber, the length of at least one said elastic projection is shorter as 0.05˜0.15 mm than space between a pair of side walls which are placed in opposition each other.

An example of holding equipment for optical fiber of the present invention can show noticeable effect for holding relevant parts to the optical fiber using of such pair-projection which is a pair of projections that space between the two projections is 0 or narrower than two times of mean diameter of a outer circle which touch and include tightly the projection inside of it in addition to using of the single projection.

An example of holding equipment for optical fiber of the present invention is characterized by that the center position of each projection not forming the pair-projection and/or the center position of each said pair-projection are placed in equivalent pitch in a direction along the fringe of the wall on at least one said side wall of at least one said holding unit.

An example of holding equipment for optical fiber of the present invention is characterized by that all the elastic projections are formed only on one side wall of a pair of said side walls which are placed in opposition each other.

In a case of a desirable example of holding equipment for optical fiber of the present invention where all the elastic projections formed only on one side wall, it is desirable that 24 of said single projection and/or said pair-projection are formed on at least one side wall of at least one holding unit for optical fiber, and each center of two nearest neighbor projections which are two nearest neighbor single projections or two nearest neighbor pair-projections or one single projection and one nearest neighbor pair-projection make the center angle of 15° against the center of said side wall.

An example of holding equipment for optical fiber of the present invention is characterized by that said elastic projections are formed on both side walls which are placed in opposition each other, of the side wall, hereinafter, to be also referred to as the first side wall and the side wall, hereinafter, to be also referred to as the second side wall, and at least one pair of said elastic projections which are placed on both side walls can be placed at the position which are in opposition each other, also can be placed at the alternate position of both side wall.

Desirable length of projections for above-mentioned case is that in a case where the projections are placed in opposition, the sum total length of both projections is longer than one fourth of space between a pair of said side walls which are placed in opposition each other, and more desirable length of projections is one half of space between a pair of side walls. And in a case of buffered fiber, when optical reliability is thought important, said sum total length of both projections of shorter as 0.05˜0.15 mm than space between the pair of side walls is desirable. In a case wherein the projections are not placed in opposition and are placed at shifted position each other, when sum total length of one projection and one of the most neighbor projection is, same as above description, longer than one fourth of space between said both side wall, an example of holding equipment for optical fiber of the present invention can show noticeable effect for wide ribbon fiber, when sum total length of one projection and one of the most neighbor projection is longer than one half of space between said both side wall, an example of holding equipment for optical fiber of the present invention can show noticeable effect also for narrow ribbon fiber, and especially to use for buffered fiber, when sum total length of one projection and one of the most neighbor projection is shorter as 0.05˜0.15 mm than space between a pair of said side walls, an example of holding equipment for optical fiber of the present invention can show noticeable effect having high reliability.

Moreover, in case where the projections are not placed in opposition, when sum total length of two projections which are one projection of one side wall and the nearest neighbor projection of the other wall is longer as 0.05˜0.24 mm than space between said both side walls, a holding equipment for optical fiber which is easy to use and has especially high reliability can be realized.

An example of holding equipment for optical fiber of the present invention in which the projections are formed on both side wall which are placed in opposition each other is characterized by that the center of each projection not forming the pair-projection and/or the center of each said pair-projection are placed in equivalent pitch in a direction along the fringe of the wall on one said side wall or both said side wall of at least one said holding unit.

An example of holding equipment for optical fiber of the present invention in which the projections are formed on both side wall which are placed in opposition each other is characterized by that 48 of said single projection and/or said pair-projection are formed on one side wall and/or both side wall of at least one said holding unit.

An example of holding equipment for optical fiber of the present invention in which the projections are formed on both side wall which are placed in opposition each other is characterized by that both of each center of two projections which are two nearest neighbor single projections or two nearest neighbor pair-projections or one single projection and one nearest neighbor pair-projection makes the center angle of 7.5 against the center of said side wall.

An example of holding equipment for optical fiber of the present invention is characterized by that at least one side wall of said side walls having elastic projections is a side wall, hereinafter, to be also referred to as a side wall comprising projections on both side, comprising plural said elastic projections on one side and the other side of the side wall.

An example of holding equipment for optical fiber of the present invention is characterized by that said side wall, plural said projections formed on the side wall and the core of reel are formed in one body.

An example of holding equipment for optical fiber of the present invention is characterized by that at least one projection of said projections is a projection, hereinafter, to be also referred to as belt styled projection or belt projection, which has such size that size of the projection measured along the fringe of the wall is lager than size of the projection measured toward the radius of the wall.

An example of holding equipment for optical fiber of the present invention is characterized by that area of cross section of root around, namely raising up place from the side wall, of said belt styled projection is lager than area of cross section of end portion of it.

An example of holding equipment for optical fiber of the present invention is characterized by that plural said belt styled projections are formed on the same side of at least one side wall.

An example of holding equipment for optical fiber of the present invention is characterized by that number of said belt styled projections which are formed on the same side of at least one side wall is four.

An example of holding equipment for optical fiber of the present invention is characterized by that a belt styled projection, hereinafter, to be also referred to as projection A, and a projection which is not a belt styled projection, hereinafter, to be also referred to as projection B, are formed on the same side of at least one side wall.

An example of holding equipment for optical fiber of the present invention is characterized by that said core of reel is formed on one side of said side wall and also said core of reel is formed on the other side of said side wall.

An example of holding equipment for optical fiber of the present invention is characterized by that size of said core of reel of one side of said side wall that is measured perpendicular direction to the wall and size of said core of reel of the other side of said side wall that is measured perpendicular direction to the wall are different.

An example of holding equipment for optical fiber of the present invention is characterized by that at least one side wall among the side wall having said elastic projections is a side wall having projections on both side of it, that is, a side wall which has plural said projections on one side and the reverse side of the wall respectively.

An example of holding equipment for optical fiber of the present invention is characterized by that space between two projections placed on one side of at least one side wall having projections on both side of it and space between two projections placed on the other side of the side wall are different space.

An example of holding equipment for optical fiber of the present invention is characterized by that shape and size of projections placed on one side of at least one side wall having projections on both side of it, and shape and size of projections placed on the other side of the side wall are different shape and size.

An example of holding equipment for optical fiber of the present invention is characterized by that only projections which are not belt styled projections are placed on one side of at least one side wall having projections on both side of it, and at least two belt styled projections are placed on the other side of the side wall.

An example of holding equipment for optical fiber of the present invention is characterized by that at least one side wall having projections on both side of it has at least two belt styled projections near to fringe of the side wall.

An example of holding equipment for optical fiber of the present invention is characterized by that projections which are not belt styled projections are placed on one side of at least one side wall having projections on both side of it, and four of belt styled projections are placed near to fringe of the other side of the side wall and, in addition, at least two pair of said pair-projections are placed at the position which is nearer position to core of reel than the position at which the belt styled projections are placed.

An example of holding equipment for optical fiber of the present invention is characterized by that distance from fringe of at least one side wall which is a side wall having projections on both side of it to the outside surface of the core of reel, that is width of the side wall, is different at one side of that side wall and the other side of that side wall.

An example of holding equipment for optical fiber of the present invention is characterized by that width of side wall having belt styled projections near to fringe of the wall which is one side of the side wall having projections on both side of it, hereinafter, to be also referred to as the second width of side wall is larger than width of side wall having projections which are not belt styled projections near to fringe of the wall which is the other side of the side wall having projections on both side of it, hereinafter, to be also referred to as the first width of side wall.

An example of holding equipment for optical fiber of the present invention is characterized in that said side wall has four of ditches or slits, namely cut parts.

An example of holding equipment for optical fiber of the present invention is characterized in that said cut part reaches to position of the core of reel on the side wall having the projections.

Though above explanation of many sorts of characteristics of holding equipment for optical fiber of the present invention is made mainly focusing characteristics of examples of elastic projections which are placed on said side wall forming the optical fiber holding area, the side wall and the core of reel, but the present invention is not limited narrowly to above mentioned characteristics, and it is obvious from above explanation and following explanation that the present invention comprises also some of the above mentioned characteristics together as there is not technical contradiction.

One of the most noteworthy characteristic of the present invention is that such holding equipment for optical fiber became practicable that diameter of holding equipment is smaller than 8 cm, being wound and being unwound of the fiber are easy, it can prevent effectively unwinding due to an accident of drop and it is inexpensive, by using an example of holding equipment for optical fiber of the present invention having the above mentioned many sorts of characteristics, while previously it was considered that to hold the relatively short length, for example 2 m or 3 m length, optical fiber winding into ring having diameter smaller than 8 cm is impossible in view of characteristics of the fiber.

In addition, followings are explanation about manufacturing such a holding equipment made of elastomers for optical fiber that can be used as is for processing vaporized deposition of antireflective layer on the terminal surface of optical fiber.

An example of holding equipment for optical fiber of the present invention is characterized by that said at least one pair of side walls and projections formed on said side wall are made of fluorinated elastomer.

An example of holding equipment for optical fiber of the present invention is characterized by that hardness of the fluorinated elastomer which forms said holding equipment for optical fiber is 70˜90 in Shore hardness.

An example of holding equipment for optical fiber of the present invention is characterized by that hardness of the fluorinated elastomer which forms said holding equipment for optical fiber is 75˜85 in Shore hardness.

An example of holding equipment for optical fiber of the present invention is characterized in that said fluorinated elastomer is vinylidenefluoride elastomer or tetrafluoroethylene-perfluorovinylether elastomer.

An example of holding equipment for optical fiber of the present invention is characterized by that contents of fluorine of said fluorinated elastomer is 65˜70%.

An example of holding equipment for optical fiber of the present invention is characterized by that said fluorinated elastomer is thermally treated for more than 1 hour at 250˜400° C. on the manufacturing process.

An example of holding equipment for optical fiber of the present invention is characterized by that said fluorinated elastomer is thermally treated for 8˜24 hours at 260˜270° C. on the manufacturing process.

An example of holding equipment for optical fiber of the present invention is characterized by that said holding equipment for optical fiber is a holding equipment which was post-vulcanized at 204˜260° C. after formed holding equipment for optical fiber.

In addition, an example of said elastic projections, side wall, core of reel of the present invention can be formed by material other than fluorinated elastomers.

An example of holding equipment for optical fiber which is not used for vacuum vaporized deposition of the present invention is characterized by that said core of reel, said at least one pair of side walls and projections formed on said side wall of at least one holding unit are made of silicone elastomer. Such holding equipment for optical fiber makes possible to provide inexpensive products.

An example of holding equipment for optical fiber of the present invention is characterized in that said silicone elastomer is colored, opaque against a visible ray.

An example of holding equipment for optical fiber of the present invention is characterized by that color of said silicone elastomer can be used for distinction of said holding equipment for optical fiber. By such application, attributes of optical fiber can be indicated easy to distinguish.

In addition, followings are explanation about more details of characteristics of composition of an example of holding equipment for optical fiber of the present invention.

An example of holding equipment for optical fiber of the present invention is characterized by that the holding equipment for optical fiber has at least two holding unit for optical fiber of the first holding unit and the second holding unit, and the first holding unit has said elastic projections on one said side wall of at least one pair of side walls which are placed in opposition each other or both said side wall of at least one pair of side walls which are placed in opposition each other.

An example of holding equipment for optical fiber of the present invention is characterized by that the second holding unit has said elastic projections on one said side wall of at least one pair of side walls which are placed in opposition each other or both said side wall of at least one pair of side walls which are placed in opposition each other.

An example of holding equipment for optical fiber of the present invention is characterized by that the second holding unit has at least one pair of side walls which have not said elastic projections.

An example of holding equipment for optical fiber of the present invention is characterized by that all of the side wall, the core of reel and the elastic projections of the first holding unit and the second holding unit are made of elastic materials.

An example of holding equipment for optical fiber of the present invention is characterized by that the first holding unit and the second holding unit are composed being able to be connected in one body by using unit-connection-part.

An example of holding equipment for optical fiber of the present invention is characterized by that said unit-connection-part is a part which connect said the first holding unit and the second holding unit in one body by inserting the part into a hole or a cavity formed on the first holding unit and into a hole or a cavity formed on the second holding unit to hold said the first holding unit and the second holding unit.

An example of holding equipment for optical fiber of the present invention is characterized by that said the first holding unit and the second holding unit are made of elastic material into one body by using one-piece molding.

An example of holding equipment for optical fiber of the present invention is characterized by that said the first holding unit and the second holding unit are made of different materials.

An example of holding equipment for optical fiber of the present invention is characterized by that the materials which construct the second holding unit are the materials having characteristics of a rigid body as a holding unit for optical fiber.

An example of holding equipment for optical fiber of the present invention is characterized by that a connection-part by which said the first holding unit can be connected with said the second holding unit in a condition of removable and re-connectable is formed in one body with the second holding unit as a extended part from the second holding unit.

An example of holding equipment for optical fiber of the present invention is characterized by that an attaching part in style of concave part or convex part that can combine with at least one of the first and the second holding unit is formed as a part of the connection-part, and a combining part which is concave part or convex part is formed on the holding unit which is connected to the attaching part.

An example of holding equipment for optical fiber of the present invention is characterized by that one side wall of a pair of side walls which are placed in opposition each other of the second holding unit is the back side of the side wall which is one of a pair of side walls of the first holding unit.

An example of holding equipment for optical fiber of the present invention is characterized by that said the second holding unit has a pair of side walls which are placed in opposition each other and different from that of the first holding unit.

An example of holding equipment for optical fiber of the present invention is characterized by that said holding equipment for optical fiber has the third holding unit for optical fiber in addition to the first holding unit and the second holding unit.

An example of holding equipment for optical fiber of the present invention is characterized by that the third holding unit is formed such structure as capable being connected with the first holding unit or the second holding unit into one body.

An example of holding equipment for optical fiber of the present invention is characterized by that the third holding unit has a pair of side walls which are placed in opposition each other, and at least one of the pair of side walls is a side wall having said projections.

An example of holding equipment for optical fiber of the present invention is characterized by that at least one of said side walls is a side wall formed as being able to be fit between two side walls after formed independently of the other component being comprised in said holding equipment for optical fiber and to construct two holding unit for optical fiber.

An example of holding equipment for optical fiber of the present invention is characterized by that at least one of said side walls is a side wall having said projections on its both side.

An example of holding equipment for optical fiber of the present invention is characterized by that at least two of said optical fiber holding area of each of at least two of said holding unit have different depth of the holding unit respectively.

An example of holding equipment for optical fiber of the present invention is characterized by that at least one of side wall constructing boundary of said two holding unit is a side wall having said ditches or slits.

An example of holding equipment for optical fiber of the present invention is characterized by that size of projection of the fringe of said side wall is within a circle having 10 cm in diameter.

An example of holding equipment for optical fiber of the present invention is characterized by that thickness of said holding equipment for optical fiber is thinner than 3 mm.

An example of holding equipment for optical fiber of the present invention is characterized in a holding equipment for optical fiber into which the optical fiber having length within 5 m can be wound, wherein the holding equipment for optical fiber comprises optical fiber holding area, where-into the optical fiber can be hold wound on a core of reel, comprising, at least, a core of reel having shape of its fringe of circle or ellipse or polygon on which optical fiber can be wound, at least one pair of side walls placed in opposition each other, connected with said core of reel or combined to said core of reel, having shape of fringe of circle or ellipse or polygon and having shape of flat board, elastic projections which are formed at place near the fringe and inner of the fringe on the side wall, stick out from the wall toward the opposite side wall, and hollow formed at the core of reel and the side walls.

Followings are explanation of holding equipment for optical fiber of the present invention, having more comprehensive characteristics than aforementioned characteristics, made of fluorinated elastomer.

An example of holding equipment for optical fiber of the present invention is characterized by that the holding equipment for optical fiber is holding equipment being able to hold the fiber by winding and made of cured fluorinated elastomer.

An example of holding equipment for optical fiber of the present invention is characterized by that hardness of said fluorinated elastomer is 70˜90 in Shore hardness.

An example of holding equipment for optical fiber of the present invention is characterized by that hardness of said fluorinated elastomer is 75˜85 in Shore hardness.

An example of holding equipment for optical fiber of the present invention is characterized by that said fluorinated elastomer is vinylidenefluoride elastomer or tetrafluoroethylene-perfluorovinylether elastomer.

An example of holding equipment for optical fiber of the present invention is characterized by that said fluorinated elastomer contains 65˜70% of fluorine.

An example of holding equipment for optical fiber of the present invention is characterized by that said fluorinated elastomer is thermally treated for more than 1 hour at 250˜400° C. on the manufacturing process.

An example of holding equipment for optical fiber of the present invention is characterized by that said fluorinated elastomer is thermally treated for 8˜24 hours at 260˜270° C. on the manufacturing process.

An example of holding equipment for optical fiber of the present invention is characterized by that said holding equipment is a holding equipment which was post-cured at 204˜260° C. after formed holding equipment.

Although the above has provided an explanation a part of the characteristics of the present invention, as described above, the present invention makes many kinds of mode practicable as described later, and an example of the present invention is characterized by that there are some cases showing one of aforementioned characteristics and showing combined characteristics of aforementioned characteristics.

### BRIEF DESCRIPTION OF DRAWINGS

FIG. 1 is a perspective view of an example of embodiment of holding equipment for optical fiber of the present invention.

FIG. 2 is a drawing that explains placement of projections of holding equipment for optical fiber of the present invention.

FIG. 3 is a drawing that explains placement of projections of holding equipment for optical fiber of the present invention.

FIG. 4 is a cross section that explains a part of holding equipment for optical fiber of the present invention.

FIG. 5 is an enlarged drawing of surroundings of optical fiber holding area of the present invention.

FIG. 6 is a drawing that explains state of optical fiber held in holding equipment for optical fiber of the present invention.

FIG. 7 is a drawing that explains another embodiment of holding equipment for optical fiber of the present invention.

FIG. 8 is a drawing that explains an example of projections placed on the side wall of holding equipment for optical fiber as an example of embodiment of the present invention.

FIG. 9 is a drawing that explains an example of projections placed on the side wall of holding equipment for optical fiber as an example of embodiment of the present invention.

FIG. 10 is a drawing that explains an example of placement of projections placed on the side wall of holding equipment for optical fiber as an example of embodiment of the present invention.

FIG. 11 is a drawing that explains an example of placement of projections placed on the side wall of holding equipment for optical fiber as an example of embodiment of the present invention.

FIG. 12 is a cross section that explains an example of holding equipment for optical fiber as an example of embodiment of the present invention.

FIG. 13 is a drawing that explains an example of holding equipment for optical fiber as an example of embodiment of the present invention.

FIG. 14 is a drawing that explains holding equipment for optical fiber as an example of embodiment of the present invention.

FIG. 15 is a drawing that explains holding equipment for optical fiber as an example of embodiment of the present invention.

FIG. 16 is a drawing that explains holding equipment for optical fiber as an example of embodiment of the present invention.

FIG. 17 is a drawing that explains holding equipment for optical fiber as an example of embodiment of the present invention.

FIG. 18 is a cross section that explains holding equipment for optical fiber as an example of embodiment of the present invention.

FIG. 19 is a drawing that explains state of optical fiber held in holding equipment for optical fiber of the present invention.

FIG. 20 is a drawing that explains state of unwinding optical fiber held in the holding equipment for optical fiber of the present invention.

FIG. 21 is a drawing that explains holding equipment for optical fiber as an example of embodiment of the present invention.

FIG. 22 is a cross section that explains holding equipment for optical fiber as an example of embodiment of the present invention.

FIG. 23 is a cross section that explains holding equipment for optical fiber as an example of embodiment of the present invention.

FIG. 24 is a drawing that explains manufacturing method of projections placed on a side wall of holding equipment for optical fiber as an example of embodiment of the present invention.

FIG. 25 is a cross section that explains an example of the ribbon optical fiber.

FIG. 26 is a cross section that explains holding equipment for optical fiber as an example of embodiment of the present invention.

FIG. 27 is a cross section that explains holding equipment for optical fiber as an example of embodiment of the present invention.

FIG. 28 is a cross section that explains holding equipment for optical fiber as an example of embodiment of the present invention.

FIG. 29 is a cross section that explains holding equipment for optical fiber as an example of embodiment of the present invention.

FIG. 30 is a drawing that explains conventional handling method of the optical fiber.

FIG. 31 is a drawing that explains conventional handling method of the optical fiber.

### BEST MODE FOR CARRYING OUT THE INVENTION

The following provides an explanation of a mode for carrying out the present invention with reference to the drawings. Furthermore, although each of the drawings used in the explanation schematically shows the dimensions, shape and layout relationship of each constituent component to a degree that enables the present invention to be understood. For the sake of convenience in providing the explanation, those components may be illustrated while partially changing the enlargement factor, those components may be illustrated only essential parts, and there are cases in which they may not always resemble the actual objects or descriptions of the embodiments and so forth. In addition, in each of the drawings, similar constituent components are indicated by assigning the same reference symbols, and duplicate explanations may be omitted.

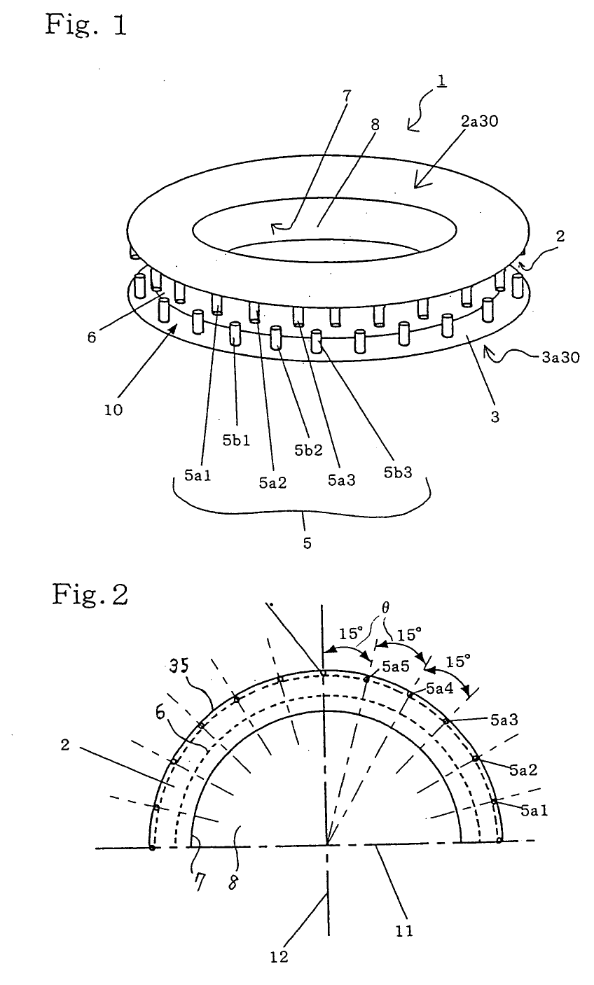

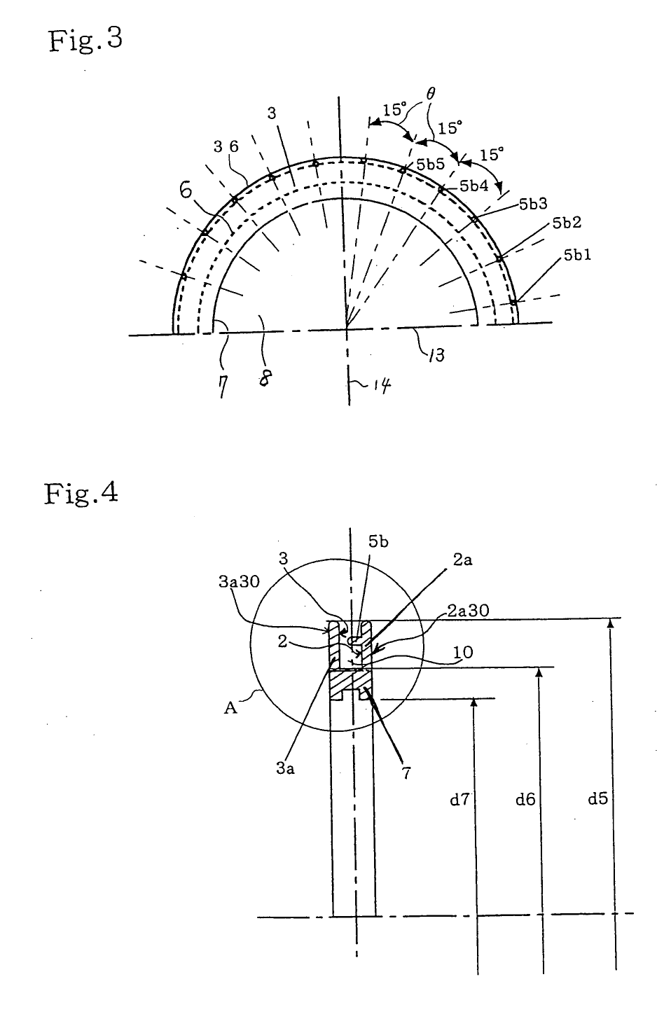

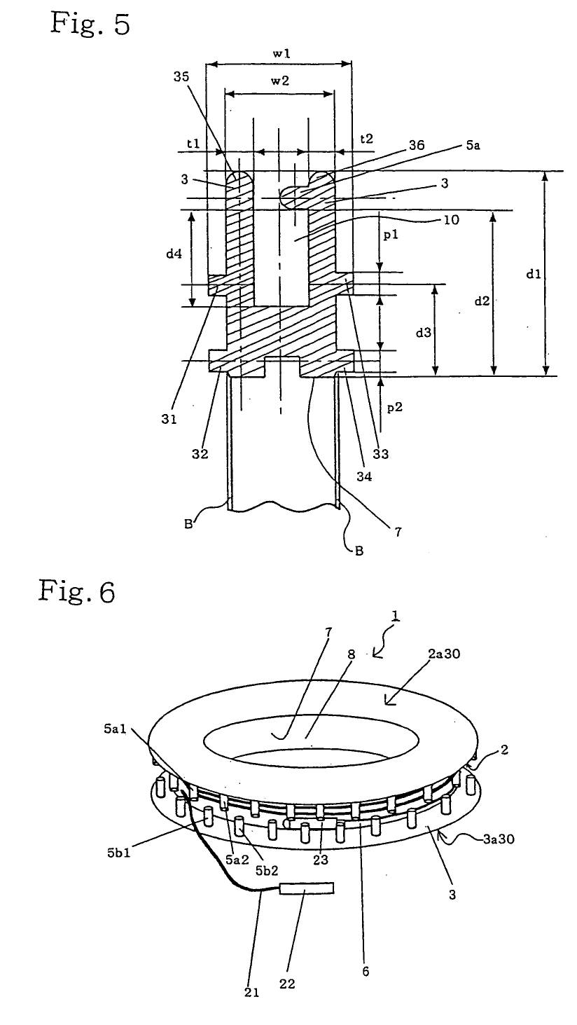

FIG. 1˜FIG. 5 are drawings that explain holding equipment for optical fiber as the first example of embodiment of the present invention, FIG. 1 is a perspective view of holding equipment for optical fiber before winding the fiber on it, FIG. 2 and FIG. 3 are drawings that explain placement of projections placed on each of side walls of the optical fiber holding area of holding equipment for optical fiber shown in FIG. 1, each of side walls shown in FIG. 2 and FIG. 3 are placed in opposition each other at the optical fiber holding area. FIG. 4 is a cross section that shows the upper half of holding equipment for optical fiber shown in FIG. 1 being cut at a position of the center line 14 shown in FIG. 3. FIG. 5 is an enlarged cross section of encircled part shown in FIG. 4, namely surroundings of optical fiber holding area.

In FIG. 1˜FIG. 5, reference symbol 1 indicates a holding equipment for optical fiber, reference symbols 2 and 3 indicate side walls which are placed in opposition each other and construct a optical fiber holding area, reference symbols 2a30 and 3a30 indicate the exterior part of side wall, reference symbols 5a1˜5a5 indicate elastic projections placed on side wall 2, reference symbols 5b1˜5b5 indicate elastic projections placed on side wall 3, reference symbol 5 is a reference symbol which indicates each of projections 5a1˜5a5, 5b1˜5b5 shown in FIG. 1 or general term for them, reference symbol 7 indicates inside part of the core of reel, namely the interior wall of the core of reel, reference symbol 8 indicates a space formed by the interior wall 7 (hereinafter, to be also referred to as hollow portion), reference symbol 6 indicates the surface of core of reel, namely the outside portion of core of reel, means the bottom surface of an optical fiber holding area 10 which will be described later, reference symbol 10 indicates an optical fiber holding area formed with side wall 2 and 3, projections 5 placed at said side walls and the bottom surface 6, reference symbols 11˜14 indicate the center line of the side wall 2 and 3, reference symbol 0 indicates an angle formed by line connected the center of side wall 2 or 3 and a projection and line connected the center of side wall 2 or 3 and the nearest neighbor projection of said projection, namely angle which is formed by two projections which are the nearest neighbor each other against the center of side wall, reference symbols 31˜34 indicate convex portion formed on the exterior wall of the side wall 2 and 3 as a processed portion, reference symbols 36 and 35 indicate edge of the side wall 2 and 3 (hereinafter, to be also referred to as fringe of the side wall), reference symbols d1˜d7, p1˜p2, t1˜t2, w1˜w2 indicate measure of each part shown in each figure that will be described later.

Further, above described side wall 2 and 3 in FIG. 1 mean the surface, indicated by reference symbols 2 and 3, of each plate which are placed inside of an optical fiber holding area 10 in opposition each other and construct an optical fiber holding area 10, but for the sake of convenience in providing the explanation, in following drawings and explanation, there are some cases about meaning of the side wall that is, for instance explaining about FIG. 1 as an example, a case where the side wall means the surface of each plate indicated by reference symbols 2 or 3, a case where the side wall means the exterior part being the back side of side wall 2, 3 (hereinafter, to be also referred to as exterior wall) indicated by reference symbols 2a30, 3a30, a case where the side wall 2, 3 means including a part should be called flesh part, indicated by reference symbols 2a, 3a in FIG. 4 that will be described later, of side wall which has the surface indicated by reference symbols 2, 3 as one side of it and the exterior wall indicated by reference symbols 2a30, 3a30 as the other side of it, a case where the side wall 2, 3 means all of the parts indicated by reference symbols 2, 3, 2a, 3a, 2a30, 3a30, a case where the side wall 2, 3 mean parts including extended parts indicated by reference symbols 2, 3, 2a, 3a, 2a30, 3a30 to the position of the core of reel or the position of hollow portion 8 in addition to above-mentioned cases, except cases that there are some fear of serious misunderstanding caused by explanation in front and/or behind and/or quotation from drawing. And in necessary case for the sake of convenience in providing the explanation, the word of the side wall will be used distinguished meaning of each case or meaning of mixed cases.

In FIG. 1, all the components of the side wall 2, 3, projections 5, the bottom surface 6, the interior wall 7 being comprised in the holding equipment for optical fiber 1, in an example of embodiment of the present invention, are made of fluorinated elastomers. The contents of fluorine of the fluorinated elastomers is 65˜70%, the hardness is 70˜90 in Shore hardness (75˜85 in Shore hardness is especially favorable). The holding equipment for optical fiber is post-vulcanized in a oven at 204˜260° C. after formed into a holding equipment, therefore, in a case where it is used in a vacuum vaporized deposition device, when the temperature is going up beyond 100° C. in a vacuum vaporized deposition device, there is no problem about out-gassing, harming to form vacuum vaporized deposition layers, due to the holding equipment.

The holding equipment for optical fiber 1 is formed by press molding process and by using above-described fluorinated elastomers. The elastic projections indicated by reference symbols 5a1˜5a5, 5b1˜5b5 are placed inside of the side walls 2 and 3, namely the side where optical fiber is held, and each of the projections 5a1˜5a5 and each of the projections 5b1˜5b5 are placed at positions which are not placed in opposition each other and such positions where each of the projections placed on the side wall 2 and each of the projections placed on the side wall 3 are located alternatively like that projection 5b1 is placed in-between projection 5a1 and projection 5a2, projection 5b2 is placed in-between projection 5a2 and projection 5a3, and so forth.

FIG. 2 is drawing that explains each of the projections placed on the side wall 2 of holding equipment for optical fiber. FIG. 2 is drawing written about a half of the circumference of side wall 2, viewing from the out side of side wall 2, in that the crossing point of the center line 11 and the center line 12 is the center of side wall 2, and each of the projections 5a1, 5a2, 5a3 . . . is placed like that each nearest two lines formed by connecting each projection and the center of side wall 2 make the center angle of 15° against the center of said side wall, for example, in FIG. 2, as shown in drawing, two lines formed by connecting projection 5a3, 5a4 and the center of side wall 2 respectively make the center angle of 15° against the center of said side wall, two lines formed by connecting projection 5a4, 5a5 and the center of side wall 2 respectively make the center angle of 15° against the center of said side wall 2, and so forth, and each of the projections is placed at the position where the side wall 2 is divided equally into 12 parts and is formed in one body with side wall 2.

FIG. 3 is drawing that explains each of the projections placed on the side wall 3 of the holding equipment 1. FIG. 3 is drawing written about a half of the circumference of side wall 3, viewing from the out side of side wall 3, in that the crossing point of the center line 13 and the center line 14 is the center of side wall 3, and each of the projections 5b1, 5b2, 5b3 . . . is placed like that each nearest two lines formed by connecting each projection and the center of side wall 3 make the center angle of 15° against the center of said side wall, for example, in FIG. 3, as shown in drawing, two lines formed by connecting projection 5b3, 5b4 and the center of side wall 3 respectively make the center angle of 15° against the center of said side wall 3, two lines formed by connecting projection 5b4, 5b5 and the center of side wall 3 respectively make the center angle of 15° against the center of said side wall 3, and so forth, and each of the projections is placed at the position where side wall 3 is divided equally into 12 parts and is formed in one body with side wall 3.

FIG. 4 is a cross section looking from the left side in FIG. 2 that shows the holding equipment for optical fiber 1 being cut at the center line 12 shown in FIG. 2 (which is located at the place overlapping with the center line 14 shown in FIG. 3). In FIG. 4, reference symbol d5 indicates diameter of the fringe of side wall 2 and 3, reference symbol d6 indicates diameter of the bottom surface of optical fiber holding area 10, namely the outside portion of the core of reel, reference symbol d7 indicates diameter of the interior wall 7.

FIG. 5 is an enlarged drawing of encircled part by circle A shown in FIG. 4, convex portions 31˜34 as a processed portions are formed on the exterior wall of side walls 2 and 3 to prevent piled side walls clinging firmly when many holding equipments for optical fiber are piled. On account of above-mentioned processed portion, it comes possible that many of holding equipments for optical fiber of the present invention can be installed in such way that many holding equipments are put to a case like magazine, pole styled body, and so on, under condition slightly pressed, for example to process by automatic machine, without such problem that plural of the holding equipments cling firmly each other, then two holding equipments are took out while one holding equipment should be took out.

Cross section of the fringe of side walls 2 and 3 shown in FIG. 5 is semicircle. Projection 5 formed sticking out from side wall 2 toward side wall 3 and projection formed sticking out from side wall 3 toward side wall 2 (not shown in the drawing) are placed under such condition that the outmost portion of the projection shifted to inner side of a required distance from fringe 36 of side wall 2 or from fringe 35 of side wall 3 toward the bottom surface 6. The slope between the outmost portion of the fringe of side wall 2 or side wall 3 and each of projections 5a1, 5a2, 5a3 . . . or 5b1, 5b2, 5b3 . . . play a role of guide for optical fiber when the fiber is wound into holding equipment for optical fiber 1, and contributes largely to making possible to perform accurately such job winding the fiber into holding equipment for optical fiber 1 and unwinding the fiber from the holding equipment for optical fiber and contributes largely to reducing working time.

Measure of d1 means a measure from the interior wall 7 of side wall 2, 3 to the fringe 35, 36 of side wall 2, 3, measure of d2 means a measure from the interior wall 7 to the interior portion of each projection 5a1, 5b1, and so on, measure of d3 means a measure from the interior wall 7 to the center of convex 31, 33 which is formed on the exterior of side wall 2, 3 as a protruded part, namely a processed portion, measure of d4 means the depth of optical fiber holding aria 10, namely a measure from the interior of each projection to the bottom surface 6 formed on the side of optical fiber holding aria. Measure of w1 means the maximum thickness measure of holding equipment for optical fiber, measure of w2 means a measure of thickness measure of the part of holding equipment for optical fiber at where the convex 31˜34 are not formed on the exterior of the side wall. Measure of t2 and t1 mean a measure of thickness measure of the part of the side wall 2, 3 at where the convex 31˜34 are not formed on the exterior of the side wall.

According to the result of experiment of the inventor of the present invention, length of the projection 5 longer than one fourth of width of the optical fiber holding area, namely space between side wall 2 and side wall 3 of the optical fiber holding area 10 is desirable for performing to wind the fiber into the holding equipment for optical fiber and to unwind the fiber of required length from the holding equipment in which the fiber is wound and held, with light force like that worker feels natural action, and also desirable to prevent some kind of obstruction to such process as, for example, attaching collimator to the terminal of the fiber held in the holding equipment for optical fiber or polishing of the terminal surface of the fiber due to unwinding the fiber from the holding equipment or deforming shape, and processing vaporized deposition of antireflective layer on the terminal surface. In FIG. 4 and FIG. 5, cases of different length of projection 5 are indicated.

In an example of embodiment of the present invention, the inventor of the present invention manufactured, as an example of the holding equipment for optical fiber described using FIG. 1˜FIG. 5, by using afore-mentioned fluorinated elastomer, the holding equipment for buffered fiber of diameter 0.25 mm having the following specifications, wherein, explaining the dimension in mm, d1=4.3, d2=3.74, d3=2, d4=2, d5=73.6 φ (φ means diameter, the same as followings), d6=69φ, d7=65φ, p1=p2=0.5, t1=t2=0.6, w1=2.6, w2=2.2, shape of cross section of fringe 36 and 35 of side wall 2 and 3 are circle having 0.3 mm as its radius, length of projection 5 is ½˜1.5/2 of space between side wall 2 and side wall 3, namely ½˜1.5/2 of width of optical fiber holding area, shape of the tip of projection 5 is sphere shape of radius of 0.25 mm, and then, as will be described later, got such result that quality of such process as to wind and hold of optical fiber, to unwind and wind the fiber of required length for some process, to attach parts for collimator to the terminal of the fiber, to polish of the terminal surface of the fiber, and so on, was improved remarkably, and in a case of forming antireflective layer, excellent antireflective layer was formed without problem of out-gassing from the holding equipment for optical fiber in a vacuum vaporized deposition device using the same holding equipment for optical fiber as described above. In FIG. 5, portions indicated by reference symbol B are tapered slope formed at border between interior wall 7 and side wall 2 and between interior wall 7 and side wall 3, and its dimension is 0.5 mm in the case of above described.

FIG. 6 is a drawing that explains a state of a holding equipment for optical fiber 1, wherein after a holding equipment for optical fiber 1 was formed into above-mentioned dimensions, as an example of above-mentioned processes, optical fiber 21 was wound into the holding equipment for optical fiber 1, then one terminal side of the optical fiber 21 was unwound out for required length from the holding equipment for optical fiber and ferrule 23 was attached to the terminal and the terminal side of the optical fiber 21 was wound into the holding equipment for optical fiber, in addition, the other terminal side of the optical fiber was unwound out for required length from the holding equipment for optical fiber and collimator 22 was attached to the terminal.

As was previously known, optical fiber having diameter of 250 μm with the first coated layer is weak against bending and hard, therefore when said unwound part for the processing of the fiber held into a conventional holding equipment is pulled or terminal around of said unwound part of the fiber held into a conventional holding equipment is moved, strong force is exercised on the fiber, then shape of the ring of the fiber is put into disorder and it become obstacle to the process, but in the case of the holding equipment for optical fiber of the present invention, when the fiber held into the holding equipment of the present invention is pulled by usual force, a part of the fiber for a length corresponding to the force is coming out from the holding equipment by slipping out reliably over the elastic projections placed as holding spring on the side wall 2 and 3, and also remaining fiber which is wound in the holding equipment except the unwound part is held into the holding equipment and kept suitably and safely in requested shape and size in the holding equipment, then strong force is not exercised on the fiber and there are no obstacle to the process due to snapping of the fiber, disorder of the shape.

In addition, even though the holding equipment for optical fiber of the present invention is formed of elastic resin like synthetic rubber, according to the effect of the convex 31˜34 which are placed on the exterior side of the side wall of the holding equipment as processed portion, it comes possible that many of holding equipments for optical fiber of the present invention can be installed in such way that many holding equipments are put into a case so-called magazine under condition of slightly pressed for field of automatic machining, without such problem which is a fatal problem for automatic machine that plural of the holding equipments cling firmly each other, then plural of holding equipments are took out while one holding equipment should be took out.

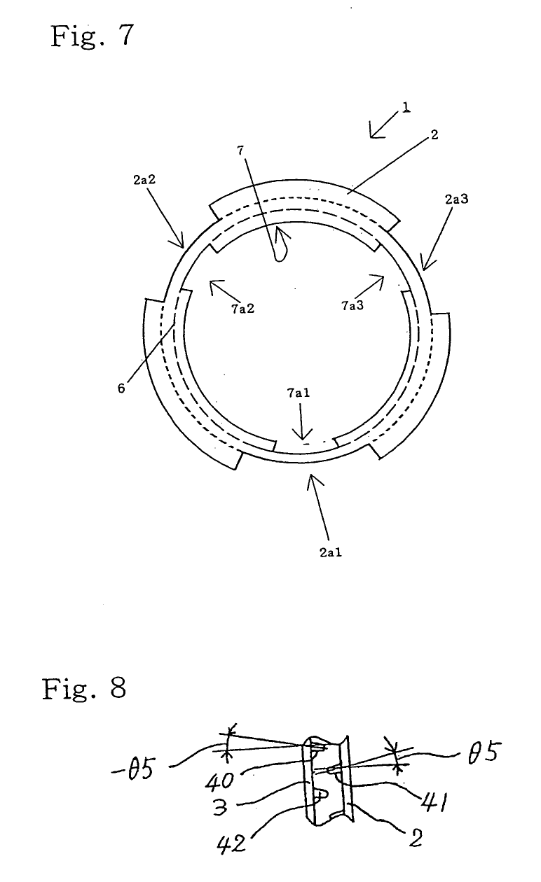

FIG. 7 is a drawing that explains an example of holding equipment for optical fiber which has ditch or slit, namely cut part, formed on side wall 2, 3 and interior wall 7 as an example of an embodiment of holding equipment for optical fiber of the present invention. In FIG. 7, reference symbols 2a1˜3 indicate the cut parts formed on the portion of optical fiber holding area of side wall 2, reference symbols 7a1˜7a3 indicate the cut parts formed on the interior wall 7.

The cut parts 2a1˜3 can be utilized in such case, for example, wherein a bundle of fiber held to the optical fiber holding area is took out as is, wherein some construct which described later is attached to the holding equipment for optical fiber as a combining means between the construct and sidewall 2, wherein optical fiber is shifted from one holding area to other holding area of the holding equipment for optical fiber which is constructed by combining plural of the holding equipments which will be described later. The cut parts 2a1˜3 placed on the side wall 2 can be formed on one of side wall 2 and 3, also can be formed on both of side wall 2 and 3, and also can be not formed on both of side wall 2 and 3, and that is selected depend on the purpose of application and/or materials of the holding equipment, and so on.

While the cut parts 2a1˜3 are used for combining means between the holding equipment and parts for control, when the holding equipment is used for some kind of automatic machine or in a vacuum vaporized deposition device, accurate operation comes possible.

Furthermore, in a case of above-described holding equipment for optical fiber of the present invention which is made of fluorinated elastomers being able to be used in vacuum by one-piece molding technology, when thickness of the side wall etc. is made too thin for the sake of convenience in taking out the bundle of optical fiber held in the holding equipment from the holding equipment as is, there are also some cases where it is not easy to handle the holding equipment for optical fiber. For the sake of convenience in application of the holding equipment for optical fiber, there are also case where material is selected over the sacrifice of bend of the holding equipment. Taking such condition into consideration, in an example of embodiment of holding equipment for optical fiber of the present invention, some constructs can be used for attaching to the holding equipment by combining with the interior wall and/or the side wall.

As an example of such construct which can combine with the holding equipment for optical fiber having dimensions of d1˜d7 described above, being not shown in the drawing, there is a construct comprising a hollow disk which can attach to the exterior surface of the side wall by touching and a hollow cylinder which is connected with said hollow disk and is used by being inserted into the interior wall 7. An example of dimensions of such construct which is used for the holding equipment for optical fiber having dimensions of d1˜d7 described above are such dimensions that thickness of the hollow disk is 0.5 mm, outside diameter of the hollow disk is 70 mm, inside diameter of the hollow disk is 63 mm (namely, thickness of hollow cylinder part is 65−63=2 mm), length of the cylinder part (namely, dimension of raising-up part from the disk) is 2.6 mm, and the tip part of the cylinder of which length is 0.8 mm is formed as a taper with angle of 15 toward inner side. According to such shape and dimensions, such construct can be inserted easily into the interior wall of the holding equipment for optical fiber, and also when the hollow cylinder of the construct is inserted until the hollow disk touches to the exterior surface of the side wall, the part where is not tapered, namely the part of which length is 1.8 mm raised up from the hollow disk is bound tightly by contracting force of said interior of the holding equipment for optical fiber, then the construct can keep its position reliably, and such construct can play a role of reinforcement for the holding equipment for optical fiber and/or combining with parts for control, then such construct can make the holding equipment for optical fiber easier being used.

FIG. 8 is a drawing that explains more specific example of projections of holding equipment for optical fiber as an example of an embodiment of the present invention. In FIG. 8, reference symbols 40˜42 indicate projections, projections 40˜42 are formed parallel to tangent line of fringe of the side wall where the projections are formed, or are formed slanted where the tip of the projection is closer to said bottom surface of the optical fiber holding area than the root of the projection, or are formed parallel to perpendicular line of the side wall where the projections are formed and toward another side wall which is placed in opposition to that side wall.

Furthermore, each projection is formed as slanted as each of the center line of projections 40 and 42 makes specified angle −θ5 with the perpendicular line of the side wall where the projections are formed, the center line of projection 41 makes specified angle θ5 with the perpendicular line of the side wall where the projection is formed. It is desirable that above specified angle θ5 is smaller than 10°, then it is easy to handle such as winding and unwinding of optical fiber, the optical fiber held in the holding equipment for optical fiber by being wound in it is hard to unwind naturally during its handling, and it is possible to hold optical fiber into the holding equipment for optical fiber with high reliability. Projections 40 and 42 are placed on the same side wall 3 and projection 41 is placed on the side wall 2 which is placed in opposition to the side wall 3.

In addition, the perpendicular component against the side wall of projections 40˜42 is longer than ¼ (one fourth) of distance between said side walls, and especially, when it is shorter as 0.05˜0.15 mm than the distance, namely the space between said side walls, the holding equipment can show such noticeable effect as keeping easy winding of optical fiber, having excellent characteristics against fall, and having high reliability of holding equipment.

The projections shown in FIG. 8 are formed slanted downward regarding fringe of the side wall in the drawing, and according to said projections formed slanted as shown in FIG. 8, soft and slimmer projections are available to prevent unwinding naturally for optical fiber wound into the optical fiber holding area and user can wind easily optical fiber when optical fiber is held into the holding equipment for optical fiber. Furthermore, when the length of the projection is longer than a half of the width of distance between said side walls, the holding equipment for optical fiber can show such noticeable effect as to prevent optical fiber unwinding and coming out from the holding equipment.

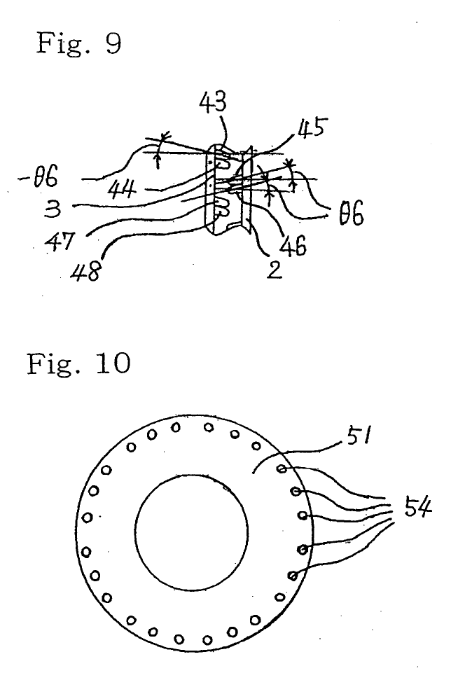

FIG. 9 is a drawing that explains another specific example of projections of holding equipment for optical fiber as an example of an embodiment of the present invention. In FIG. 9, reference symbols 43˜48 indicate projections, the projections can be formed parallel to tangent line of fringe of the side wall where the projections are formed, or slanted toward inside of optical fiber holding area wherein the tip of the projection is closer to said bottom surface of the optical fiber holding area than the root of the projection, or parallel to perpendicular line of the side wall where the projections are formed and toward another side wall which is placed in opposition to that side wall.

Projection 43˜48 are formed as slanted as each of the center line of projections 43, 44, 47, 48 makes specified angle −θ6 with the perpendicular line of the side wall, each of the center line of projection 45, 46 makes specified angle θ6 with the perpendicular line of the side wall. It is desirable that above specified angle θ6 is smaller than 10°, then it can realize holding equipment having excellent handling characteristics. Furthermore, projections 43, 44, 47, 48 are placed on the same side wall, and projections 43, 44 and projections 47, 48 are closely placed respectively as forming such pair-projection that space between two roots of projection is 0 or narrower than two times of diameter of a outer circle which touch and include tightly the root of projection inside of it. Projections 45 and 46 are also placed on the side wall which is placed in opposition to the side wall on that projections 43, 44, 47, 48 are placed, and projections 45 and 46 are placed as forming pair-projection too. In addition, when the perpendicular component to the side wall of the length of projections 43˜48 is longer than ¼ of distance between said side walls, and especially, when it is shorter as 0.05˜0.15 mm than the distance, namely the space between said side walls, the holding equipment can show such noticeable effect as being easy to handle, having excellent characteristics against fall, namely, even for buffered fiber, being able to prevent a part of the fiber coming out from the holding equipment on account of fall by accident, and having high reliability of holding equipment.

When the projections are formed slanted to one direction concerning with the fringe of the side wall, for example downward in the drawing, namely where the position of the tip of the projection is lower than the position of the root of the projection as shown in FIG. 9, the holding equipment becomes more easy to handle for winding and holding optical fiber. When the projections are closely placed, some kind of parts can be hold between the closely placed projections.

Furthermore, when the perpendicular component to the side wall of the length of the projection is longer than a half of distance between said side walls, the holding equipment for optical fiber can show such noticeable effect as to prevent optical fiber unwinding and coming out from the holding equipment.

Projections shown in FIG. 8 and FIG. 9 are examples of layout of projections wherein projections are placed on both side walls which are placed in opposition each other and are placed alternately along the fringe direction of said side walls, namely like that one projection of the projections is placed at a place on side wall 2, the next projection is placed on side wall 3, following projection is placed on side wall 2 again, and so on.

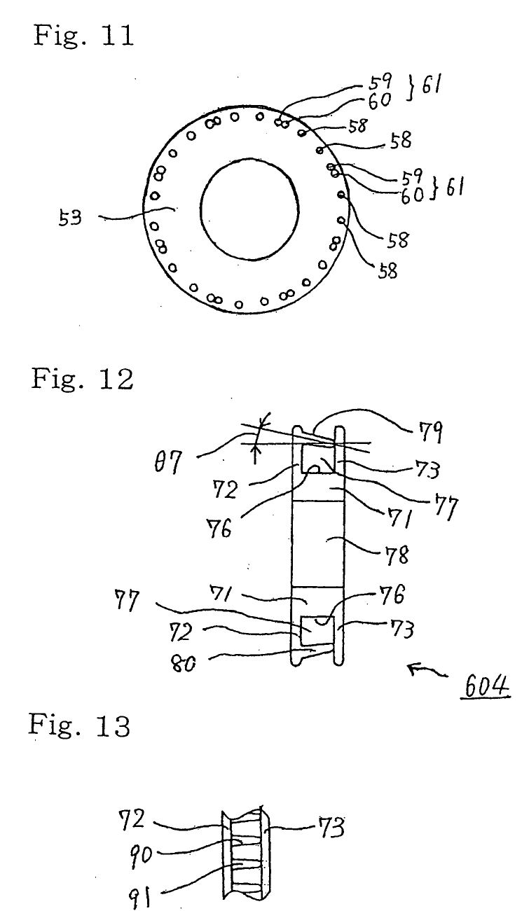

FIG. 10 and FIG. 11 are drawings that explain examples of layout of projections of examples of holding equipments for optical fiber of the present invention. In the drawings, reference symbols 51, 53 indicate side wall, reference symbols 54 and 58˜60 indicate projections, reference symbol 61 indicates a pair-projection in which two projections are placed closely. In FIG. 10, projections 54 are placed on side wall 51 in equivalent space.

In FIG. 11, projections 58˜60 are placed on side wall 53 in such way where projections 59 and 60 are formed as their roots contact each other, projection 58 is formed as its root does not contact with other projection, and projections are placed in such way where two projections of singly placed are placed, following that one pair-projection comes, and so on, and pitch of each two neighbor projections that is space between two neighbor singly placed projections or one singly placed projection and the center of the next pair-projection are equivalent intervals.

FIG. 12˜FIG. 16 are drawings that explain examples of embodiment of holding equipment for optical fiber of the present invention where the projections are placed on one side wall of a pair of side walls placed in opposition each other and the projection is not placed on the other side wall of said pair of side walls placed in opposition each other.

FIG. 12 is a cross section that explains an example of holding equipment for optical fiber as an example of embodiment of the present invention. In FIG. 12, reference symbol 604 indicates holding equipment for optical fiber of the present invention, reference symbol 71 indicates core of reel constructing the holding equipment for optical fiber of the present invention, reference symbols 72, 73 indicate side walls which are connected with or closely placed to the core of reel, and are placed in opposition each other, reference symbol 76 indicates outside surface of the core of reel which is inside part of the side wall 72 and 73, reference symbol 77 indicates optical fiber holding area which is a space formed with outside potion of the core of reel 76, side wall 72 and 73, projections 79, 80 which will be described later and other projections (not shown in the drawing), reference symbol 78 indicates hollow portion, reference symbols 79, 80 indicate elastic projections which are placed on the side wall 72 and protrude toward side wall 73. The projections 79 and 80 can be formed parallel to tangent line of fringe of the side wall where the projections are formed, or slanted toward inside of optical fiber holding area where the tip of the projection is closer to the bottom surface of the optical fiber holding area than the root of the projection, or parallel to perpendicular line of the side wall where the projections are formed and toward another side wall which is placed in opposition to that side wall.

The center line of projections 79 and 80 and other projections (not shown in the drawing) are formed as slanted toward bottom surface, namely outside potion of the core of reel, as the center line makes specified angle θ7 with the perpendicular line of the side wall where the projections are placed.

It is desirable that above specified angle θ7 is smaller than 10°, then it can realize holding equipment having excellent characteristics of easy handling and high reliability.

According to said projections formed slanted as shown in FIG. 12, soft and slimmer projections become available to prevent unwinding naturally optical fiber wound into the optical fiber holding area and it is possible to wind easily into the holding equipment for optical fiber.

FIG. 13˜FIG. 16 are drawings that explain example of projections of holding equipment for optical fiber explained about FIG. 12, viewing holding equipment for optical fiber from the out side of the projections.

In FIG. 13, reference symbols 90 and 91 indicate projections, and projections 90 and 91 are formed perpendicular to the side wall at the position where they are placed. Projections 90 and 91 are formed on the same side wall 72. Length of projections 90 and 91 are longer than ¼ of distance between said side walls and shorter than distance between said side walls.

As a result of said projections formed longer than ¼ of distance between said side walls and shorter than the distance between said side walls as shown in FIG. 13, it can prevent effectively optical fiber unwinding and coming out from the holding equipment. Furthermore, when the length of the projection is shorter as 0.05˜0.15 mm than the distance, namely the space between said side walls, the holding equipment can show such noticeable effect as being easy to handle, having excellent characteristics against fall. Namely, even under such condition as not so strong resistance against winding optical fiber into the holding equipment for optical fiber, there is no fear of coming out for the optical fiber wound into the holding equipment from the holding equipment on account of fall of the holding equipment by accident during handled, and it is possible to keep optical fiber into the holding equipment for optical fiber with high reliability.

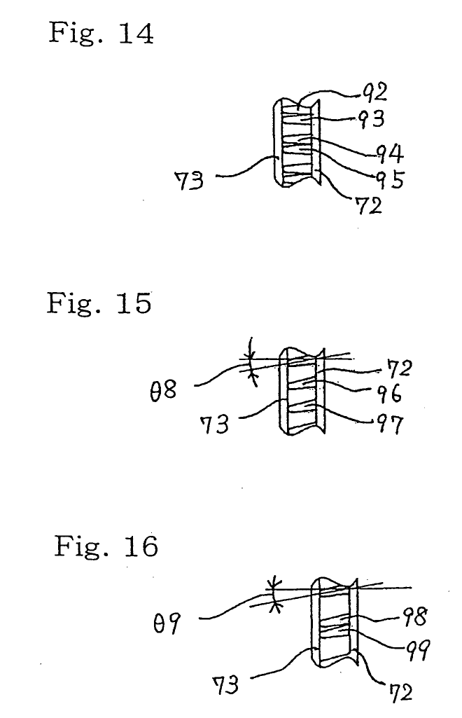

In FIG. 14, reference symbols 92˜95 indicate projections, and projections 92˜95 are formed perpendicular to the side wall 72 on which they are formed and protrude toward side wall 73 which is placed parallel to side wall 72 and in opposition with side wall 72. Projections 92, 93 and projections 94, 95 are pair-projections respectively formed as their roots contact each other. Regarding to the length of the projection and its effect, it is same as above-mentioned cases.

In FIG. 15, reference symbols 96 and 97 indicate projections, and the center line of projections 96 and 97 are formed as being inside of the plane, which is parallel to fringe of side wall 72, at the root of each projection and as slanted as each projection makes specified angle θ8 with the perpendicular line of the side wall 72. When above specified angle θ8 is smaller than 10°, then it can realize easy to use holding equipment. Projections 96 and 97 are formed on the same side wall 72. Each length of projections 96 and 97 measured perpendicular to the side wall is longer than ¼ of distance between said side walls and shorter than distance between said side walls.

When the projections are formed slanted to one direction concerning with the fringe of the side wall, for example downward in the drawing as shown in FIG. 15, then optical fiber can be installed easily into the holding equipment for optical fiber. Furthermore, when the length of the projection is longer than a half of distance between said side walls and shorter than distance between said side walls, the holding equipment for optical fiber can show such noticeable effect as to prevent unwinding for optical fiber wound into it and coming out from it for optical fiber.

In FIG. 16, reference symbols 98 and 99 indicate projections, and projections 98 and 99 are formed as slanted as each projection makes specified angle θ9 with the perpendicular line of the side wall. Projections 98 and 99 are formed on the same side wall 72, its length measured perpendicular to the side wall are longer than ¼ of distance between said side walls and shorter than distance between said side walls.

When the projections are formed slanted to direction concerning with the fringe of the side wall, for example downward in the drawing, namely where the position of the tip of the projection is lower than the position of the root of the projection as shown in FIG. 16, the holding equipment becomes for optical fiber more easy to be installed. When the projections are closely placed as the two roots of projection are contacted or space between two roots of projection is narrower than diameter of a root of the projection, some kind of parts can be hold between the closely placed projections. And as similar to the case of FIG. 13, when length of projection measured perpendicular to the side wall is longer than one half of distance between said side walls, it can prevent effectively for optical fiber unwinding and coming out from the holding equipment.

In addition, projection explained in FIG. 13˜FIG. 16 can be placed as projection explained in FIG. 10 and FIG. 11.

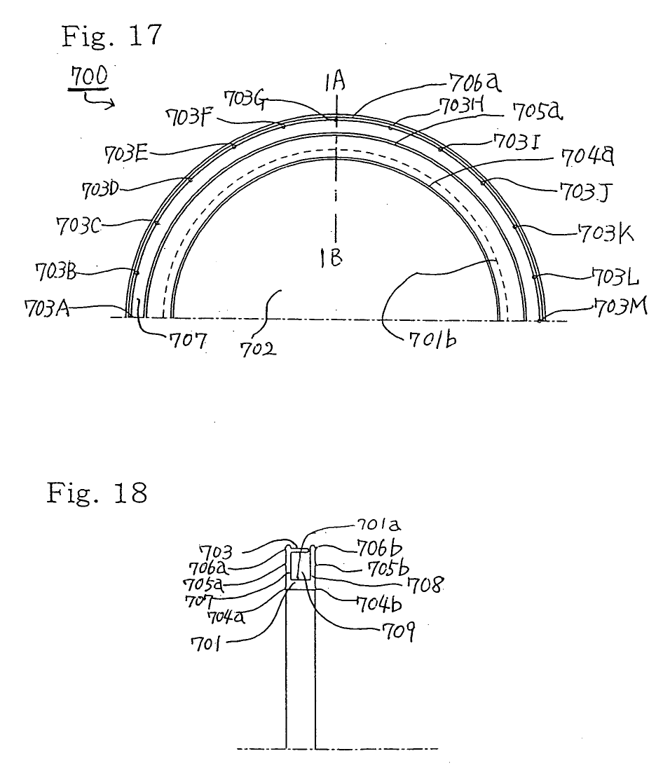

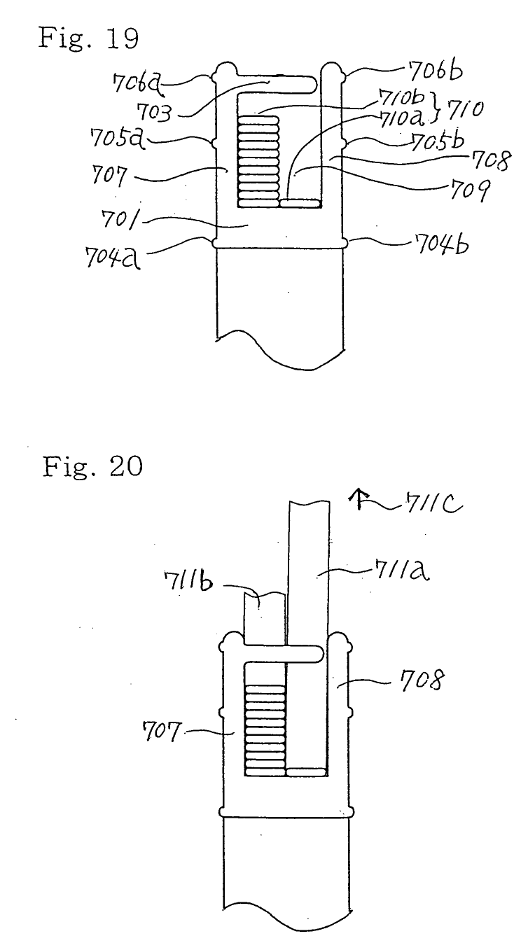

FIG. 17˜FIG. 20 are drawings that explain holding equipment for optical fiber as example of embodiment of the present invention, explain example of holding equipment for optical fiber comprising two side walls having three convex portion for each side wall as example of processed portion, where projections are formed on only one side wall of said two side walls. FIG. 17 is a drawing that shows a half of holding equipment for optical fiber of the present invention, viewing from perpendicular direction to the side wall, FIG. 18 is a cross section where holding equipment for optical fiber is cut at line 1A-1B shown in FIG. 17, FIG. 19 is a cross section that explains state of holding ribbon fiber, wherein plural buffered fiber were put side by side and formed into ribbon, installed in holding equipment for optical fiber of the present invention, which is enlarged optical fiber holding area shown in FIG. 18, FIG. 20 is a cross section that explains state of unwinding ribbon fiber held in the holding equipment for optical fiber of the present invention.

In FIG. 17˜FIG. 20, reference symbol 700 indicates holding equipment for optical fiber of the present invention, reference symbol 701 indicates elastic core of reel constructing holding equipment 700 for optical fiber, reference symbol 701a indicates outside portion of core of reel as outside surface of core of reel 701, reference symbol 701b indicates line to show the position of outside portion 701a, reference symbols 707 and 708 indicate elastic side wall connected to core of reel 701, reference symbol 702 indicates hollow portion formed inside part of core of reel 701, side wall 707 and side wall 708, reference symbols 703A, 703B, 703C, 703D, 703E, 703F, 703G, 703H, 7031, 703J, 703K, 703L, 703M indicate mark indicating position of elastic projections (in FIG. 17, can not see because of placed on backside of side wall 707) that is placed on side wall 707 and protrude from side wall 707 toward side wall 708, and hereinafter, there are also cases to show projection itself. Also, hereinafter, reference symbol 703 also indicates sometimes each of projection 703A, 703B, 703C, 703D, 703E, 703F, 703G, 703H, 7031,703J, 703K, 703L, 703M or general term of them. Reference symbols 704a, 705a, 706a indicate convex portion as processed portion formed on side wall 707, Reference symbols 704b, 705b, 706b indicate convex portion as processed portion formed on side wall 708, in addition, processed portion 704a and 704b, processed portion 705a and 705b, processed portion 706a and 706b are symmetrical layout with respect to a plane which is intermediate between side wall 707 and side wall 708 respectively, hereinafter, reference symbol 704, 705, 706 indicate sometimes each of one symmetrical pair of processed portion 704a and 704b, processed portion 705a and 705b, processed portion 706a and 706b or general term of them. Reference symbol 709 indicates optical fiber holding area which is formed with core of reel 701, side wall 707 and 708 and projections 703, reference symbol 710 indicates optical fiber installed into the holding equipment for optical fiber of the present invention, reference symbol 710a indicates the first one turn of the installed optical fiber which is wound first, reference symbol 710b indicates a part of optical fiber 710 except the first one turn 710a. Reference symbol 711a indicates a drawing out part which is near portion to a terminal of the first one turn of optical fiber 710 that is wound first, reference symbol 711b indicates a drawing out part as near portion to a terminal that locate the other side of the drawing out part 711a.

In FIG. 17 and FIG. 18, projections 703 are placed equivalent intervals each other and at the equivalent distance from the outside portion of core of reel 701a, and core of reel 701, side wall 707, 708, projections 703 and processed portion 704, 705, 706 are formed in one body by one-piece molding technology using elastomers, intending to elastic body. Furthermore, processed portion 704, 705, 706 are processed, as a suitable example, by heat treatment after coated saturated polymer surface reform processing material on at least a part of the surface of the side wall. Processed portion 704 is formed along innermost position, namely interior of side wall 707 and 708. Processed portion 705 is formed on side wall 707 and 708, at the position that is outside part of the side wall and corresponding to the outside portion of core of reel 701a and corresponding to inside part of the portion where the projections are placed. Processed portion 706 is formed in such place where inner fringe of the processed portion is at a position corresponding to the center of projection 703 and outer fringe of the processed portion is at slightly inner position from fringe of the side wall 707, 708.

Projection 703 is formed protruded from side wall 707 toward side wall 708, is formed perpendicular to the side wall 707, or slanted as forming specified angle specified angle θa with the perpendicular line of the side wall 707 measured toward the outside portion of core of reel 701a, or slanted as forming specified angle θb with the perpendicular line of the side wall 707 measured to the perpendicular line of the side wall 707 along fringe direction of the side wall, or slanted as both of said angle θa and angle θb are exist. It is desirable that above specified angle θa and θb are smaller than 10 from easy handling and hard unwinding point of view.

It is desirable that length as height of projection 703 measured perpendicular to the side wall 707 toward side wall 708 is longer than ¼ of distance between side wall 707 and side wall 708, then the holding equipment can be used for wider applications. In addition, when its length is longer than ½ of distance between side wall 707 and side wall 708 and is shorter as 0.05˜0.15 mm than distance between side wall 707 and side wall 708, the holding equipment can show such noticeable effect that it is easy to install, easy to attach collimator to the fiber using the holding equipment in which the fiber is installed, easy to process vaporized deposition of antireflective layer on the terminal surface of the fiber, and there is no fear of coming out the optical fiber wound into the holding equipment from the holding equipment due to fall of the holding equipment by accident during handled.

FIG. 19 is a drawing that explains state of ribbon fiber installed in holding equipment for optical fiber. In FIG. 19, optical fiber 710 is installed in such state that the first one turn 710a of the optical fiber is installed close to side wall 708 side and a part 710b which is a part of optical fiber 710 excepted the part 710a is installed close to side wall 707 side.

FIG. 20 is a drawing that explains more detailed state shown in FIG. 19. In FIG. 20, a drawing out part 711a is coming out through side wall 708 side of optical fiber holding area 709, a drawing out part 71b is coming out through side wall 707 side of optical fiber holding area 709 to out side of the optical fiber holding area.

When optical fiber 710 is installed into the holding equipment for optical fiber explained using FIG. 17˜FIG. 20, the beginning part of the optical fiber to be wound is pressed on the projection 703 and that part of the projection 703 is bent, and optical fiber 710 is put into optical fiber holding area 709, then optical fiber 710 is wound to outside portion of core of reel 701a. When optical fiber installed in optical fiber holding area 709 is taking out, the optical fiber is unwound out by holding the drawing out part 711a or 711b.

When thus optical fiber 710 of ribbon fiber is installed into the holding equipment for optical fiber explained using FIG. 17˜FIG. 20, due to forming such optical fiber holding area 709 where side wall 707 and side wall 708 are formed parallel each other, distance between side wall 707 and side wall 708 is slightly larger than two times of a width of the ribbon fiber, and existing of drawing out part 711a, entangling of optical fiber 710 can be avoid in such way that by pulling drawing out part 711a after winding the fiber into the optical fiber holding area 709, the first one turn 710a of optical fiber is pressed to side wall 708 side and remaining part of optical fiber 710 except the first one turn 710a is pressed to side wall 708 side orderly.

By making the projection 703 of appropriately flexible materials, optical fiber can be drawing out from either terminal side.

In addition, due to existing of processed portion 704, 705, 706, many of the holding equipment for optical fiber of the present invention can be treated piled up without fear of clinging firmly each other, and a large quantity of the holding equipment for optical fiber can be installed in small space.

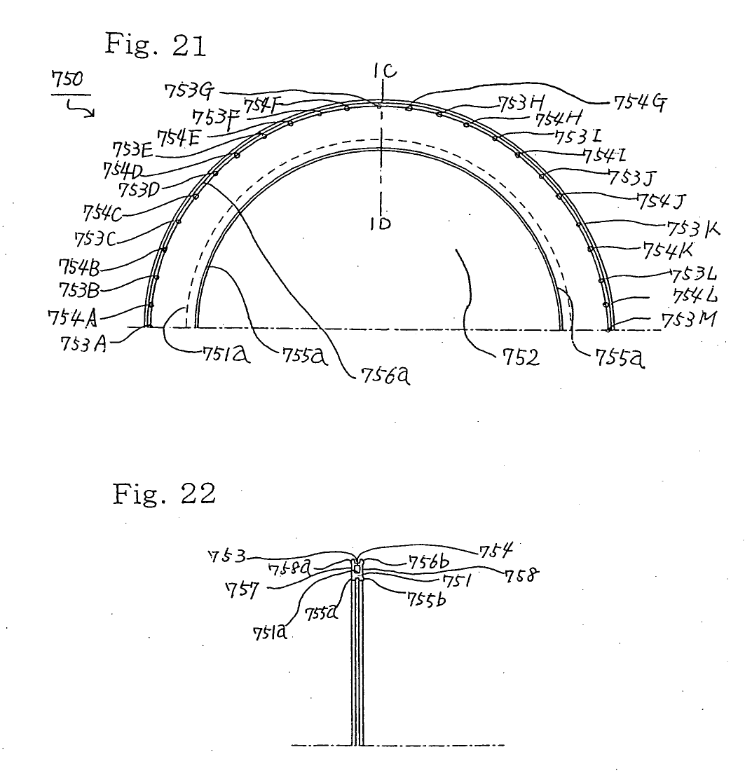

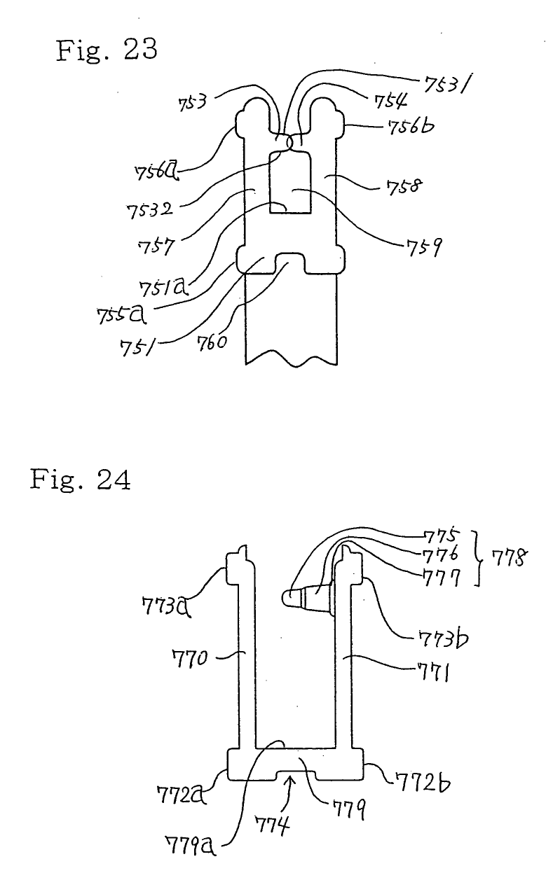

FIG. 21˜FIG. 24 are drawings that explain holding equipment for optical fiber as example of embodiment of the present invention, explain example of holding equipment for optical fiber comprising two side walls having two convex portion respectively as processed portion and projections formed on both side walls. FIG. 21 is a drawing that shows a half of holding equipment for optical fiber of the present invention, viewing from perpendicular direction to the side wall, FIG. 22 is a cross section where holding equipment for optical fiber is cut at line 1C-1D shown in FIG. 21, FIG. 23 is a cross section where optical fiber holding area around shown in FIG. 22 is enlarged, FIG. 24 is a cross section that explains manufacturing method of the projection placed on the side wall of holding equipment for optical fiber of the present invention.

In FIG. 21 FIG. 24, reference symbol 750 indicates holding equipment for optical fiber of the present invention, reference symbol 751 indicates elastic core of reel constructing holding equipment 750 for optical fiber, reference symbol 751a indicates outside portion of core of reel 751 as outside surface of core of reel, reference symbols 757 and 758 indicate elastic side walls, reference symbol 752 indicates hollow portion formed inside part of core of reel 751, side wall 757 and side wall 758, reference symbols 753A, 753B, 753C, 753D, 753E, 753F, 753G, 753H, 7531, 753J, 753K, 753L, 753M indicate mark indicating position of elastic projections that is placed on side wall 757, and hereinafter, there are also cases to show projection itself. Also, hereinafter, reference symbol 753 indicates sometimes each of projection 753A, 753B, 753C, 753D, 753E, 753F, 753G, 753H, 7531, 753J, 753K, 753L, 753M or general term of them. Reference symbols 754A, 754B, 754C, 754D, 754E, 754F, 754G, 754H, 7541, 754J, 754K, 754L, 754M indicate mark indicating position of elastic projections that is placed on side wall 758, and hereinafter, there are also cases to show projection itself. Also, hereinafter, reference symbol 754 indicates sometimes each of projection 754A, 754B, 754C, 754D, 754E, 754F, 754G, 754H, 7541, 754J, 754K, 754L, 754M or general term of them. Reference symbols 755a, 756a indicate convex portion as processed portion formed on side wall 757, reference symbols 755b, 756b indicate convex portion as processed portion formed on side wall 758, in addition, processed portion 755a and 755b, processed portion 756a and 756b are symmetrical layout with respect to a plane which is intermediate between side wall 757 and side wall 758 respectively, hereinafter, reference symbol 755, 756 indicate sometimes each of one symmetrical pair of processed portion 755a and 755b, processed portion 756a and 756b or general term of them. Reference symbol 759 indicates optical fiber holding area which is formed with core of reel 751, side wall 757, 758 and projections 753, 754, reference symbol 760 indicates attaching part formed at interior surface of core of reel 751. Reference symbols 770, 771 indicate side walls, reference symbols 772a, 773a indicate convex portion as processed portion formed on side wall 770, reference symbols 772b, 773b indicate convex portion as processed portion formed on side wall 771, reference symbol 779 indicates elastic core of reel, reference symbol 774 indicates attaching part formed at interior surface of core of reel 779, reference symbol 778 indicates projection formed on side wall 771 constructed with portion indicated by reference symbols 775˜777 which will be described later, reference symbol 775 indicates tip of projection 778, reference symbol 776 indicates middle part of projection 778, reference symbol 777 indicates base part of projection 778.

In FIG. 21 and FIG. 22, each of projections 753 and each of projections 754 are placed equivalent intervals each other on the circle of which the center is the center of each side wall respectively, in such way that, for example like projection 753A and projection 754A, projection 753B and projection 754B, each two of neighbor projections shows equivalent interval. Core of reel 751, side walls 757, 758, projections 753 and projections 754 are formed in one body by one-piece molding technology using elastomers.

Processed portion 755, 756 are processed by surface processing and/or heat treatment, then they do not cling firmly each other when they are pressed. Processed portion 755 is formed along innermost position side wall 757 and 758, namely interior of side wall 757 and 758, and placed slightly inner position of outside portion of core of reel on side wall 757 and 758. Processed portion 756 is formed in such place where inner fringe of the processed portion 756 is placed slightly outer position than the position corresponding to the center of projection 753, 754, and outer fringe of the processed portion 756 is placed slightly inner position from fringe of the side wall 757, 758.

Projection 753 is formed protruded from side wall 757 toward side wall 758, is formed perpendicular to the side wall 757, or slanted as forming specified angle θc with the perpendicular line of the side wall 757 measured toward the outside portion of core of reel 751a, or slanted as forming specified angle θd measured to the perpendicular line of the side wall 757 along fringe direction of the side wall, or slanted as both of said angle θc and angle θd are exist. It is desirable that above specified angle θc and θd are smaller than 10, when angle θc and θd are 5˜10°, it can realize holding equipment showing such excellent characteristics as easy to install even by weak force and to prevent reliably unwinding optical fiber installed in that.

In FIG. 23, attaching part 760 is a ditch or slit formed at the middle of interior surface of core of reel 751, the construct, for an example ring of metal, can be inserted into the ditch to reinforce the holding equipment for optical fiber of the present invention. Due to that, the holding equipment becomes hard to deform, easy to be used for many kind of automatic machine.

Projection 753 and 754 look as contact in FIG. 23, but in practice they are separated as shown in FIG. 21. It is desirable that length as height of projection 753 measured perpendicular to the side wall 757 toward side wall 758 is longer than ¼ of distance between side wall 757 and side wall 758, then the holding equipment can be used for wider applications. In addition, when its length is longer than ½ of distance between side wall 757 and side wall 758 and is shorter as 0.05˜0.15 mm than distance between side wall 757 and side wall 758, the holding equipment can show such noticeable effect that it is easy for optical fiber to be installed in the case of buffered fiber, easy to be attached collimator to the fiber using the holding equipment in which the fiber is installed, easy to be processed for vaporized deposition of antireflective layer on the terminal surface of the fiber, and it is effectively prevented for optical fiber wound into the holding equipment to come out from the holding equipment on account of fall of the holding equipment by accident during handled. About length of projection 754, it is the same as case of projection 753. When sum total length of one projection 753 and one projection 754 is longer as 0.05˜0.24 mm than space between side wall 757 and side wall 758, the holding equipment for optical fiber which is easy to be used and has especially high reliability can be realized, for example when sum total length of said both projections is 1.14 mm for 0.93 mm of the space between side wall 757 and side wall 758, the holding equipment for optical fiber showing can show high reliability.

Shape of cross section of the projection in the direction where the projection protrude, like projection 703, is a stick styled projection, when all of the projections are placed only on one side wall of a pair of side walls which are placed in opposition each other, almost the same bigness of projection is available from the vicinity of the root to the vicinity of the tip, the shape of the vicinity of the root is raising up as arc from the surface of side wall 707, the shape of the tip is hemisphere. Such shape shows such preferable effect as excellence in work and high reliability of handling.

When the projections are placed on both side wall of a pair of side walls which are placed in opposition each other as projections 753 and 754, it is desirable to form projection becoming thinner gradually from root toward tip, for example in cross section of FIG. 23, to form projection becoming thinner gradually from root toward tip as both outline 7531 and 7532 making angle 2˜15° and to form the tip part into roundness like a part of sphere. The raising up part, namely the vicinity of the root of the projection is desirable to be formed raising up with shape of roundness like a part of sphere. Because of such shape of the projection, the holding equipment can show such noticeable effect that it is easy for optical fiber to be installed into it, easy to be drew out from the optical fiber holding area for necessary length to do said works and avoidable to be drew out too long in the work, and it is effectively prevented for optical fiber wound into the holding equipment to come out from the holding equipment on account of fall of the holding equipment by accident during handled. About projection 754 it is the same as above-mentioned.

In FIG. 24, processed portion 772a and processed portion 772b are formed extended from position corresponding to interior surface of core of reel 779, namely inner fringe of side wall 770 and side wall 771 to position corresponding to exterior surface 779a of core of reel 779. Processed portion 773a and processed portion 773b are formed slightly inner side from the outmost fringe of side wall 770 and side wall 771.

Attaching part 774 is a ditch formed at the middle of interior surface of core of reel. Application and effect of that is the same as case of attaching part 760 explained by using FIG. 23.

Projection 778 is an example of projection which can show almost the same effect as the effect of the projection having desirable shape explained by using FIG. 21˜FIG. 23, and to save manufacturing cost. Projection 778 is, as shown in FIG. 24, formed the middle part 776 on the base part 777, the tip 775 on the middle part 776. Projection 778, side wall 770, 771 and core of reel 779 are formed by one-piece molding technology.

About making molding pattern to forming projection 778, at the first, female pattern is formed into shape of the base part 777, next to it, the middle part of the base part 777 is delved into shape of the middle part 776, next to it, the middle part of the middle part 776 is delved cavity into shape of the tip 775, then molding pattern for projection 778 is formed. Such shape of molding pattern is relatively easy to be made, reduction of manufacturing cost can be realized. Though characteristics of projection having such shape is not completely the same as that of projection 753, 754, but it shows similar characteristics.

It is possible to realize the holding equipment for optical fiber of the present invention of which said side wall has such smaller size than 10 cm in maximum size in radius direction, or in diameter in a case of circular fringe of the side wall. Previously it was considered that to hold optical fiber winding into such compact holding equipment is impossible in view of said characteristics of the fiber as solidity and easy to be snapped. But according to research of the inventor of the present invention, it is proved that summing additional idea with above composition, the holding equipment for optical fiber of the present invention can be realized such smaller diameter of said side wall than 10 cm of course, even than 8 cm.

As example of the present invention described using FIG. 21˜FIG. 23, the inventor of the present invention manufactured, by using fluorinated elastomers which will be described later, 200 pieces of the holding equipment for optical fiber having following specifications, wherein, diameter of the core of reel was 6.8 cm, diameter of interior surface of the core of reel was 6.5 cm, diameter of fringe of the side wall 757 and 758 was 7.36 cm, dimension from exterior of the side wall 757 to exterior of the side wall 758, namely thickness of the holding equipment excluding said processing part was 2.2 mm, thickness of the holding equipment including said processing part was 2.6 mm, width of the processing part was 0.7 mm, space of the side wall 757 and 758 was 0.93 mm, distance from the center of root of the projection 753, 754 to outside portion of the core of reel was 1.85 mm, diameter of root of projection 753, 754 was 0.46 mm, length of projection 753 and projection 754 was 0.57 mm, distance from fringe of the side wall to the center of projection was 1.1 mm, and the inventor of the present invention performed said jobs after installed optical fiber into the holding equipment, then such results was gotten that quality of job was excellent, many kind of process was able to be performed as to attach optical parts to the terminal of the fiber, to polish of the terminal surface, to form antireflective layer on the terminal surface of the fiber, to deliver the fiber. During such processing, there were no accident of snapping for optical fiber which was serious problem previously. Due to above, working time was remarkably shorten, excellent antireflective layer was able to be formed without problem of out-gassing in a case of forming antireflective layer, and cost of parts was remarkably reduced. In addition, when a buffered fiber is put into the holding equipment, automatic winding of the fiber into the holding equipment was performed by winding machine using stick styled magazine to which several tens of the holding equipments are mounted under condition of slightly pressed, without aforementioned problem that plural of the holding equipments cling firmly each other due to said processed portion.

Furthermore, when optical fiber is installed into the holding equipment for optical fiber by user's hands, a part of the optical fiber is put and pressed on the projection 753 or the projection 754, and the projection 753 or the projection 754 is bent toward inner side of the optical fiber holding area, and the optical fiber is put into optical fiber holding area 759, and then the optical fiber is wound to outside portion of core of reel 751a.

In addition, when side wall 757 and side wall 758 are formed in such shape that the shape of vicinity of fringe of each side wall has outline of arc in the cross section shown in FIG. 22 and FIG. 23 and space between side wall 757 and side wall 758 is becoming wider from position where the projection is formed toward outside direction of the holding equipment, above-mentioned change of the space between side wall 757 and side wall 758 plays a role of guide for winding optical fiber into the holding equipment, and the holding equipment shows such remarkable effect that, for example, to wind into the holding equipment becomes easy, and user can wind optical fiber into the holding equipment by machine very accurately and at high-speed.

While such optical fiber wound into the holding equipment for optical fiber having above-mentioned measure for the outside portion of core of reel and the fringe of side wall intend to unwind to larger diameter, due to effect of suitable structure of the holding equipment for optical fiber of the present invention, especially effect of the elastic projections 753 and 754, the optical fiber is being kept in the holding equipment for optical fiber without unwinding spontaneously due to effect of suitable structure of the holding equipment for optical fiber of the present invention, especially effect of the elastic projections 753 and 754. In addition, in a case of the holding equipment for optical fiber of the present invention, it is not needed that the optical fiber is fixed by compulsion using tape to be kept in regular shape, as needed in the conventional case, furthermore, if pulling force is exercised over the optical fiber during work, it does not occur that the optical fiber is bent to smaller diameter than diameter of the outside portion of core of reel and there is no fear of snapping of the optical fiber as occurred in conventional case. In addition, since the optical fiber is not pulled out from the holding equipment except necessary length of it during work, there is no fear of jumbling of the fiber in handling for processing, and it does not need large space for work.

As described above, in a case where the optical fiber is being held in the holding equipment explained using FIG. 21˜FIG. 23, the optical fiber held in the holding equipment is easily drew out, by constructing projections 753 and 754 using appropriately flexible material. Furthermore, due to existing of processed portion 755, 756, when many of the holding equipment for optical fiber of the present invention can be kept in custody piled up without fear of clinging firmly each other, or the optical fiber is wound into the holding equipment for optical fiber, wherein many of the holding equipment for optical fiber is mounted to the magazine of a optical fiber winding machine, a large quantity of optical fiber can be treated using small apace without fear of clinging firmly for holding equipment each other.

The shape of projection in examples of embodiment of the present invention as explained with reference to the drawings FIG. 1˜FIG. 23, being obvious from drawings and its explanation, can be applied to projections having slender shape, for example a shape like a pole or a flat shape, in addition, it is obvious from drawings and a part of its explanation that the present invention can be also applied to projections having other shape. In the present invention, the projection is applicable to elastic projection, for example, as so-called belt styled projection which has such size at the position where the projection is placed that size of the projection measured along the fringe of the wall is lager than size of the projection measured toward the radius of the wall (namely depth of the projection) and length of the projection is shorter than size of the projection measured along the fringe of the wall.

In a case where the belt styled projection is used, it is desirable from winding and unwinding point of view of the fiber that size of the projection measured along the fringe of the side wall is less than a half of size of the fringe of side wall measured along the fringe of the side wall at the position where the projection is placed, especially the size is less than one fourth of that, and the projection is used together with said slender shaped projection.

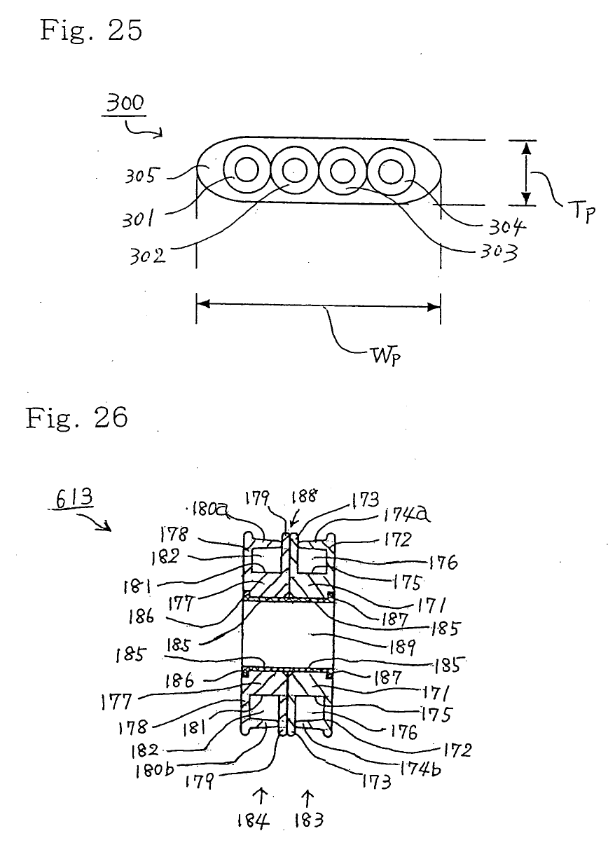

FIG. 25 is a drawing that explains an example of conventional ribbon fiber used in an explanation about the holding equipment for optical fiber of the present invention with FIG. 19 and FIG. 23, and is a cross section where the ribbon optical fiber is cut perpendicularly to the length direction of the fiber. The ribbon optical fiber in the drawing is a fiber which is packaged four buffered fibers putting them side by side and covered with resin in tape state.

In FIG. 25, reference symbol 300 indicates ribbon optical fiber, symbols 301˜304 indicate buffered fiber, reference symbol 305 indicates coated layer, reference symbol Tp indicates thickness of the ribbon optical fiber, reference symbol Wp indicates width of the ribbon optical fiber.

In a case of installing of 4-ribbon fiber having such size that width Wp is 1˜1.1 mm, thickness Tp is 0.3 mm into the holding equipment for optical fiber of the present invention explained using FIG. 17˜FIG. 24, when width of the optical fiber holding area, namely space between 2 side walls, is wider as 0.4˜0.6 mm than width of the ribbon fiber and is 2˜2.5 times of width of the ribbon fiber, winding and unwinding of the ribbon fiber is performed very smoothly.

Thickness of 8-ribbon fiber is 0.3 mm and width of it is 2˜2.2 mm, and in addition to that as ribbon fiber there are many kinds of ribbon fiber like 2-ribbon fiber, 12-ribbon fiber and width of them are different while thickness of them are almost the same. To consider above-mentioned fact is useful when the holding equipment is used for ribbon fiber.

A holding unit having an optical fiber holding area which comprises side walls placed in opposition each other and elastic projections placed on at least one said side wall as explained using FIG. 1˜FIG. 24, hereinafter, is also referred to as the first holding unit.

Furthermore, followings are explanation about example of the holding equipment comprising the second holding unit having another optical fiber holding area in addition to the first holding unit having an optical fiber holding area which comprises said elastic projections placed in the vicinity of fringe of the side wall explained using FIG. 1˜FIG. 24.

FIG. 26 is a cross section that explains an example of the holding equipment for optical fiber as an example of embodiment of the present invention, wherein the holding equipment is constructed by combination of two optical fiber holding area each of that has side walls at least a pair of which are monotonous board and placed in opposition each other, and elastic projections placed in the vicinity of fringe of at least one side wall, and the optical fiber is installed through the space between fringes of side walls, as explained using FIG. 1˜FIG. 24.

In FIG. 26, reference symbol 613 indicates holding equipment for optical fiber of the present invention, reference symbol 171 indicates core of reel, reference symbols 172, 173 indicate side walls placed by connecting with core of reel or closing to core of reel, and placed in opposition each other, reference symbols 174a and 174b indicate elastic projections formed sticking out from side wall 172 toward side wall 173, also, hereinafter, reference symbol 174 indicates sometimes each of projection 174a, 174b, and other projections, not shown in the drawing, placed in the vicinity of fringe of side wall 172 or general term of them. Reference symbol 175 indicates outside surface of core of reel 171, reference symbol 176 indicates the first optical fiber holding area which is hollow portion formed with outside surface of core of reel 175, side wall 172 and 173 and projections 174, reference symbol 183 indicates the first holding unit constructed with the parts indicated reference symbols 171˜176, reference symbol 177 indicates core of reel, reference symbols 178 and 179 indicate side walls placed by connecting with core of reel 177 or closing to core of reel 177, and placed in opposition each other, reference symbols 180a and 180b indicate elastic projections formed sticking out from side wall 178 toward side wall 179. Also, reference symbol 180 indicates sometimes each of projection 180a, 180b, and other projections, not shown in the drawing, placed in the vicinity of fringe of side wall 178 or general term of them. Reference symbol 181 indicates outside surface of core of reel 177, reference symbol 182 indicates the second optical fiber holding area which is hollow portion formed with outside surface of core of reel 181, side wall 178 and 179 and projections 180, reference symbol 184 indicates the second holding unit constructed with the parts indicated reference symbols 177˜182, reference symbol 185 indicates unit-connection-part to connect the first holding unit 183 and the second holding unit 184, reference symbol 186 indicates attaching part to mount the holding unit 184 to unit-connection-part 185, reference symbol 187 indicates attaching part to mount the holding unit 183 to unit-connection-part 185, reference symbol 188 indicates gap between the first holding unit 183 and the second holding unit 184. Gap 188 is formed according to application of holding equipment for optical fiber.

Into the first holding unit 183 optical fiber is mainly installed by wound and into the second holding unit 184 parts attached to the optical fiber are installed, and the optical fiber can travel between the first holding unit 183 and the second holding unit 184 through ditch or slit formed at the side wall 173 and 179. Reference symbol 189 indicates hollow portion formed at the center part of side wall 172, 173, 178, 179 and unit-connection-part 185 which locate at the center part of core of reel 171 and 177.

In FIG. 26, the first holding unit 183 comprising core of reel 171, side walls 172 and 173, projections 174, outside surface of core of reel 175, and the second holding unit comprising core of reel 177, side walls 178 and 179, projections 180, outside surface of core of reel 181 are made of elastomer such as silicone elastomer, fluorinated elastomer. The first holding unit 183 and the second holding unit 184 are connected in one body by using unit-connection-part. Unit-connection-part is constructed with plastic product.

In a case where optical fiber is installed into the holding equipment for optical fiber constructed by using the side wall having ditches or slits explained using FIG. 7 for at least one side wall of side wall 172, 173, 178, 179 in FIG. 26, for example, when the side wall having ditches or slits are used for side wall 173 and 179, optical fiber is wound into one of the first holding unit 183 and the second holding unit 184, and in the necessity the optical fiber can travel from one to the other holding unit through the ditch or slit formed in said side wall 173 and 179, then the optical fiber can be installed into one of the holding units and a part attached to the terminal of the fiber and/or other parts attached to the fiber can be installed into the other holding unit, and the holding equipment for optical fiber can be formed small and easy to be used.

In addition, it is obvious from the explanation about the present invention that other side wall than the side wall explained using FIG. 7 are available for side wall explained using FIG. 26. As an suitable example of the side wall having ditches or slits explained using FIG. 7, it is especially desirable that width of the ditch or slit, namely measure from one end to the other end, is larger than 15° of the center angle being formed against the center of the side wall, number of ditches or slits is four and the side wall is made of elastomers, for the optical fiber to be wound easily, to be able to prevent snapping of the fiber in handling, and to be able to keep the shape of the holding equipment for optical fiber. In an example of FIG. 26, it is desirable that the ditch or slit is formed at the same position on the side wall 173 and 179 respectively. In addition, by forming the first holding unit 183 and the second holding unit 184 such as each depth of them are different, namely each thickness of core of reel are different, installing of the optical fiber and attached parts can be performed more effectively.

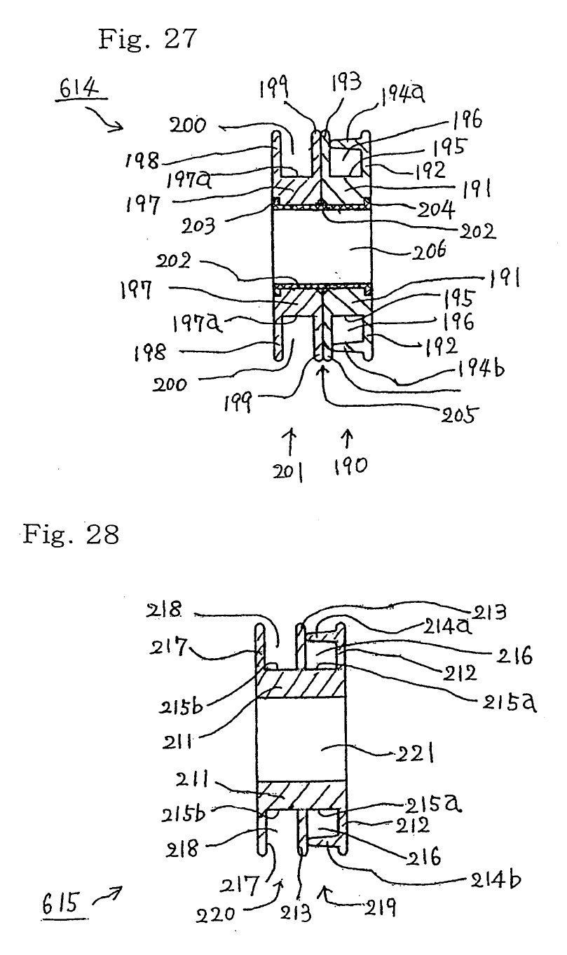

FIG. 27 is a cross section that explains an example of the holding equipment for optical fiber as an example of embodiment of the present invention, wherein the holding equipment comprises one optical fiber holding area which has elastic projections placed in the vicinity of fringe of side wall, as explained using FIG. 1˜FIG. 24, and one optical fiber holding area which has not elastic projection.

In FIG. 27, reference symbol 614 indicates holding equipment for optical fiber of the present invention, reference symbol 191 indicates core of reel, reference symbols 192 and 193 indicate side walls placed by connecting with core of reel or closing to core of reel, and placed in opposition each other, reference symbols 194a and 194b indicate elastic projections formed on side wall 192 sticking out from side wall 192 toward side wall 193. Hereinafter, reference symbol 194 indicates sometimes each of projection 194a, 194b and other projections, not shown in the drawing, placed in the vicinity of fringe of side wall 192 or general term of them. Reference symbol 195 indicates outside surface of core of reel 191, reference symbol 196 indicates the first optical fiber holding area which is hollow portion formed with outside surface of core of reel 195, side walls 192 and 193 and projections 194, reference symbol 190 indicates the first holding unit constructed with the parts indicated reference symbols 191˜195, reference symbol 200 indicates the second optical fiber holding area which is formed with core of reel 197, side wall 198 and side wall 199 and connected to the first optical fiber holding area 190, reference symbol 201 indicates the second holding unit comprises core of reel 191 and side walls 198, 199, reference symbol 202 indicates unit-connection-part to connect the first holding unit 190 and the second holding unit 201, reference symbol 203 indicates attaching part to mount the second holding unit 201 to unit-connection-part 202, reference symbol 204 indicates attaching part to mount the holding unit 190 to unit-connection-part 202, reference symbol 205 indicates gap between the first holding unit 190 and the second holding unit 201, reference symbol 197a indicates outside surface of core of reel 197. Gap 205 is formed according to application of holding equipment for optical fiber.

In FIG. 27, the first holding unit 190 comprising core of reel 191, side walls 192 and 193, projections 194, outside surface of core of reel 195 is made of elastomer, and the second holding unit 201 comprising core of reel 197, side wall 198 and side wall 199 is constructed with plastic product. The first holding unit 190 and the second holding unit 201 are connected in one body by using unit-connection-part 202.

According to construct the holding equipment for optical fiber in such way where at least two side walls of side wall 192, 193, 198, 199 are formed as the same side walls having ditch or slit as explained using FIG. 7 and FIG. 26, not shown in the drawings, inside parts, namely interior, of core of reel 191 and core of reel 197 are formed of the same shape and diameter each other, and thickness of core of reel 197 is thinner than thickness of core of reel 191, the optical fiber can be installed mainly into the first holding unit 190 and terminal parts and attaching parts in a case of existing can be installed mainly into the second holding unit 201, and the holding equipment for optical fiber can be formed small and easy to be used. The characteristics of ditch or slit formed in the side wall and its application are the same as case of FIG. 26.

When optical fiber is installed into the holding equipment for optical fiber 614 which is constructed as shown in FIG. 27, the optical fiber wound to the outside surface of core of reel 195 and intending to unwind to larger diameter is held by projections 194 and kept to be held in the optical fiber holding area 196 without unwinding spontaneously.

FIG. 28 is a cross section that explains a holding equipment for optical fiber as an example of embodiment of the present invention, wherein the holding equipment comprises one optical fiber holding area which has said elastic projections placed in the vicinity of fringe of side wall, as explained using FIG. 1˜FIG. 24, and one optical fiber holding area which has not elastic projection, and is an example in which the first holding unit and the second holding unit are formed in one body using one-piece molding technology where elastomer like synthetic rubber is molded into pattern.

In FIG. 28, reference symbol 615 indicates holding equipment for optical fiber of the present invention, reference symbol 211 indicates core of reel, reference symbols 212, 213 and 217 indicate side walls formed in one body with core of reel 211 and placed in opposition each other, reference symbols 214a and 214b indicate elastic projections formed on side wall 212 sticking out from side wall 212 toward side wall 213. Reference symbol 214 indicates sometimes each of projection 214a, 214b and other projections which are, not shown in the drawing, formed sticking out from side wall 212 toward side wall 213 and placed in the vicinity of fringe of side wall 212 or general term of them. Reference symbol 215a indicates the first outside surface of core of reel 211 between side wall 212 and side wall 213, reference symbol 216 indicates an optical fiber holding area as the first optical fiber holding area which is hollow portion formed with outside surface of core of reel 215a, side walls 212 and 213 and projections 214, reference symbol 215b indicates the second outside surface of core of reel 211 between side wall 213 and side wall 217, reference symbol 218 indicates the second optical fiber holding area formed with side wall 213, side wall 217 and outside surface 215b of core of reel, reference symbol 219 indicates the first holding unit comprising the parts indicated reference symbols 211˜214 and 215a, reference symbol 220 indicates the second holding unit constructed with the parts indicated reference symbols 213, 215b and 217. Application of the first holding unit 219 and the second holding unit 220 and its effect are the same as the case FIG. 26, FIG. 27. Reference symbol 221 indicates hollow portion formed at the center portion of core of reel 211.

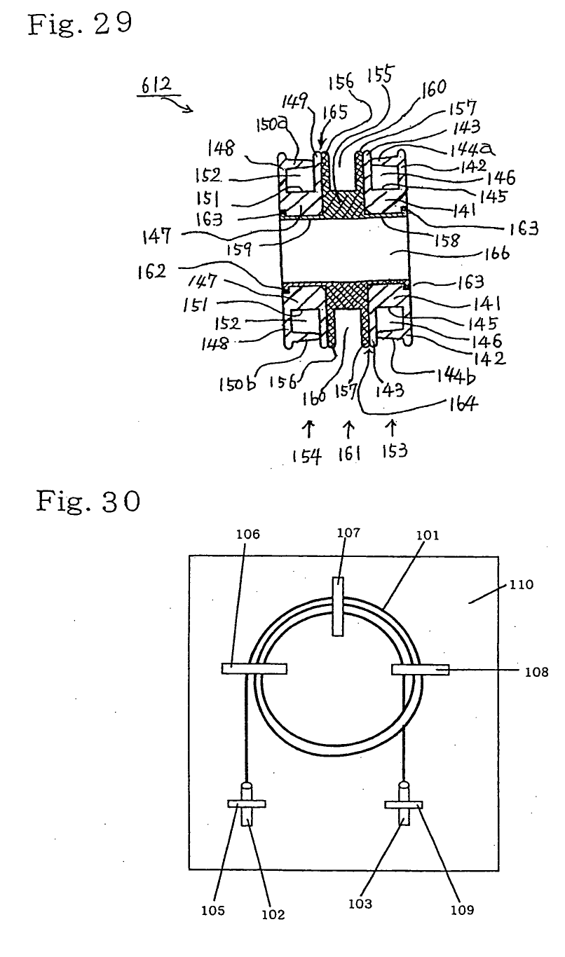

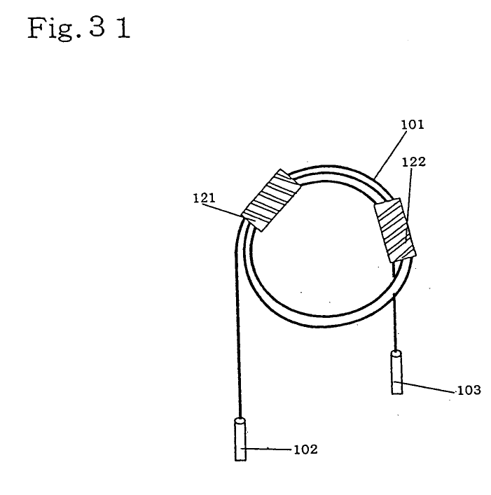

FIG. 29 is a cross section that explains a holding equipment for optical fiber as an example of embodiment of the present invention, wherein the holding equipment comprises two optical fiber holding area which have said elastic projections placed in the vicinity of fringe of side wall, as explained using FIG. 1 FIG. 24, and one optical fiber holding area which has not elastic projection and is placed between said two optical fiber holding area.

In FIG. 29, reference symbol 612 indicates holding equipment for optical fiber of the present invention, reference symbol 141 indicates the first core of reel constructing holding equipment for optical fiber of the present invention 612, reference symbols 142 and 143 indicate side walls placed by connecting with core of reel 141 or closing to core of reel, and placed in opposition each other, reference symbols 144a and 144b indicate elastic projections formed on side wall 142 sticking out from side wall 142 toward side wall 143, reference symbol 144 indicates sometimes each of projection 144a, 144b and other projections, not shown in the drawing, placed in the vicinity of fringe of side wall 142 and playing the same role as projections 144a, 144b or general term of them. Reference symbol 145 indicates outside surface of core of reel 141, reference symbol 146 indicates the first optical fiber holding area which is hollow portion formed with outside surface of core of reel 145, side walls 142 and 143 and projections 144, reference symbol 153 indicates the first holding unit comprising the parts indicated reference symbols 141˜145, reference symbol 147 indicates the second core of reel constructing holding equipment for optical fiber of the present invention, reference symbols 148 and 149 indicate side walls placed by connecting with core of reel 147 or combining with core of reel, and placed in opposition each other, reference symbols 150a and 150b indicate elastic projections formed on side wall 148 sticking out from side wall 148 toward side wall 149. Reference symbol 150 indicates sometimes each of projection 150a, 150b and other projections, not shown in the drawing, placed in the vicinity of fringe of side wall 148 or general term of them. Reference symbol 151 indicates outside surface of core of reel 147, reference symbol 152 indicates the third optical fiber holding area which is hollow portion formed with outside surface of core of reel 151, side wall 148 and 149 and projection 150, reference symbol 154 indicates the third holding unit constructing with the parts indicated reference symbols 147˜151, reference symbol 160 indicates the second optical fiber holding area formed with core of reel 155, side wall 156 and side wall 157, reference symbol 161 indicates the second holding unit comprising core of reel 155, side wall 156 and 157, unit-connection-part 158 and 159, and connected or combined with holding unit 153 and 154, reference symbol 158 indicates unit-connection-part between the second holding unit 161 and the first holding unit 153, reference symbol 159 indicates unit-connection-part between the second holding unit 161 and the third holding unit 154, reference symbol 162 indicates attaching part to mount the third holding unit 154 to the second holding unit 161, reference symbol 163 indicates attaching part to mount the first holding unit 153 and the third holding unit 154 to the second holding unit 161, reference symbol 164 indicates gap between the first holding unit 153 and the second holding unit 161, reference symbol 165 indicates gap between the third holding unit 154 and the second holding unit 161. There are cases where the gap 164, 165 are not necessary and cases where suitable gaps 164, 165 are convenient for some applications.

The optical fiber can travel between the first holding unit 153 and the second holding unit 161 through ditch or slit, for example as explained using FIG. 29, formed at the side wall 143 and 157, and the optical fiber can travel between the third holding unit 154 and the second holding unit 161 through ditch or slit formed at corresponding position (namely, the same position) of side wall 149 and 156.

Reference symbol 166 indicates a hollow portion formed at the center part of core of reel 155 that is placed at the center part of side wall 142, 143, 148, 149, 156 and 157. The thickness of core of reel 141, core of reel 147 and core of reel 155 can be the same thickness, and, for example, in a case of optical fiber being wound into holding equipment for optical fiber 612 where the optical fiber is such that an optical component like filter is connected at the middle part of the optical fiber, namely the first optical fiber and the second fiber having suitable length are connected to the both end of the optical component, and connecter is attached at the terminal of the first optical fiber and the second fiber respectively, when the first optical fiber and the second optical fiber are held into the first holding unit and the third holding unit by wound respectively, the fiber travels between holding units through the ditch or slit formed in the side wall existing between each two holding units, and the optical component is held into the second holding unit, then-the holding equipment for optical fiber can be used as a compact, excellently reliable, and excellent to be used holding equipment for optical fiber to treat relatively short optical fiber, that could not be expected in conventional holding system. In above-mentioned case, by forming such the second holding unit that the space between the side walls of the second holding unit is wider than the space between the side walls of other holding unit and/or the depth of optical fiber holding area of the second holding unit is deep (namely, the thickness of core of reel is thin), the optical components and/or connecters can be held compactly.

In FIG. 29, the first holding unit 153 comprising core of reel 141, side wall 142 and 143, projections 144, outside surface of core of reel 145 and the third holding unit 154 comprising core of reel 147, side wall 148 and 149, projections 150, outside surface of core of reel 151 are made of elastomers, and the second holding unit 161 comprising core of reel 155, side wall 156 and 157, attaching part 158 and 169 is made of plastic. Furthermore, for some application, it is more effective that the second holding unit is made of metal such as aluminum, titanium alloy, magnesium alloy, stainless steel.

The first holding unit 153 and the second holding unit 161, and the third holding unit 154 and the second holding unit 161 are connected in one body by unit-connection-part 158 and 159 respectively.

The first holding unit 153 and the third holding unit 154 are placed symmetrically with respect to the second holding unit 161, and such construction can reduce manufacturing cost.

When optical fiber is installed into the holding equipment for optical fiber, as shown in FIG. 29, in which diameter of outer fringe of the side walls of the first and the second holding unit is 75 mm respectively, diameter of the core of reel is 69 mm, the optical fiber wound to the outside surface of core of reel 145 and/or 151 and intending to unwind to out side direction is held by projections 144 and/or 150 respectively and kept to be held in the optical fiber holding area 146 and/or 152 without unwinding spontaneously.

In addition, it is obvious from the above and following explanation about the present invention that other side wall than the side wall explained using FIG. 7 are available for side wall explained using FIG. 29. Furthermore, in a case of side wall made of elastomers, namely synthetic rubber, when number of ditches or slits shown in FIG. 7 is 1˜4, the optical fiber is especially easy to be wound and the holding equipment for optical fiber can keep its shape.

Followings are explanation about an example of manufacturing of fluorinated elastomers which can be used for the present invention. Fluorinated elastomers being used in an example of embodiment of the present invention are bridge constructed fluorinated elastomers, thermal treatment in high temperature will be explained later is performed in its manufacturing process, and for example, compound of fluorinated elastomers (A1) or thermoplastic fluorinated elastomers (A2) are used.

As compound of fluorinated elastomers (A1), compounds of fluorinated elastomer made of following fluorinated elastomer by added, in necessity, curing agent, vulcanization promoter, acid accepter, filler are used.

As fluorinated elastomers, conventional materials can be used widely, for example, followings can be listed up vinylidenefluoride elastomers, tetrafluoroethylene-propylene elastomers, tetrafluoroethylene-perfluorovinylether elastomers, perfluoro-silicone elastomers, perfluorophosphagen elastomers and so on.

As vinylidenefluoride elastomers, specifically, there are, for example, copolymer elastomers of vinylidenefluoride (Vdf) and hexafluoropropylene elastomers (HFP) (for example: Viton A-200, DDE Co. Ltd.), copolymer elastomers of vinylidenefluoride and pentafluoropropylene elastomers, copolymer elastomers of vinylidenefluoride and chlorotrifluoroethylene elastomers, ternary polymerization elastomers of vinylidenefluoride (Vdf), hexafluoropropylene (HFP) and tetrafluoroethylene (TFE) for example: Viton B, Viton F, GF, DDE Co. Ltd.), as tetrafluoroethylene-propylene elastomers, there is, for example, copolymer elastomers of tetrafluoroethylene (TFE) and propylene (Pr) (for example, Afulas, Asahigalasu Co. Ltd.), as tetrafluoroethylene-perfluorovinylether elastomers, there is, for example, elastomers in which a little monomer for bridge construction is added to copolymer elastomers of tetrafluoroethylene and perfluorovinylether elastomers, as fluorophosphagen elastomers, there is, for example, elastomers which is made by reaction of long-chain rubber (PNCl2)n which is made from thermal resolution of trimer of dichlorophosphonitrile and fluoroalcoholate, and as perfluoro-silicone elastomers, there is, for example, copolymer elastomers of methyltrifluoropropylsiloxane and vinylmethylsiloxane. In such fluorinated elastomers, vinylidenefluoride elastomers and tetrafluoroethylene-perfluorovinylether elastomers are desirable.

As examples of curing (vulcanizing) agent, there are amine-curing agent (a), polyol-curing agent (b), peroxide-curing agent (c), triazine-curing agent (d), as amine-curing agent (a), specifically, followings can be listed up, for example, hexamethyenediaminecarbamate, N,N′-dicinnamylidene-1,6-hexanediamine, hexamethylenediamine carbamate, and so on, as polyol-curing agent (b), followings can be listed up bisphenol A F, 4,4′-dihydroxylationdiphenyl, and so on, as peroxide-curing agent (c), followings can be listed up, for example, α,α′-bis (t-butylperoxy-m-isopropyl) benzene (Perbutyl: Nofcorpotation), 2,5-dimethyl-2,5-di(t-butylperoxy) hexane (Perhexa 25B Nofcorpotation), dicumylperoxide (Percumyl D: Nofcorpotation), 2,5-dimethyl-2,5-(t-butylperoxy) hexyne-3 (Perhexyne 25B: Nofcorpotation), benzoylperoxide (Nyper B: Nofcorpotation), and so on, as triazine-curing agent (d), triazine can be listed up.

As vulcanization promoter, specifically, followings can be listed up, for example, triallylisocyanurate (Taic: Nipponkasei Chemical Co. Ltd.), ethyleneglycol-dimethacrylate (Sanester EG: Sanshin Chemical Ind. Ltd.), trimethylolpropanetrimethacrylate (Sanester TMP: Sanshin Chemical Ind. Ltd.), polyfunctionalmethacrylatemonomer (Hi-cross M: Seiko Chemical Co. Ltd.), polyhydricalcoholmethacrylate and acrylate, metal acid of methacrylate, and so on.

As acid acceptors, specifically, followings can be listed up dihydric oxide, hydroxide or compound of dihydrometalic compound and metallic acid. As dihydric metal, specifically, there are magnesium, calsium, lead, zinc, and so on. Such metals are used as oxide or hydroxide, or compound with week metal acid such as stearic acid, benzoic acid, carbonic acid, oxalic acid, phosphorous acid and so on.

As such acid acceptors, more specifically, followings can be listed up, for example, Ca (OH)₂, MgO, and so on. As vulcanization accelerator, there are, for example, quaternaryphosphonium salt, quaternaryammonium salt, quaternaryammonium salt of 8-alkyl (or, aralkyl)-1,8-diazabicyclo[5.4.0]-7-undecene, aminophosphinic acid derivative and so on.

As filler, specifically, followings can be listed up, for example, carbon black, barium sulfate, titanium dioxide, calcium carbonate, magnesium silicate (talc), aluminum silicate (clay), and so on.

For such compound of fluorinated elastomers, against 100 weight of fluorinated elastomers, 0.5˜10 weight of curing agent, desirably 0.5˜5 weight of curing agent, 1˜20 weight of vulcanization promoter, desirably 3˜10 weight of vulcanization promoter, 1˜40 weight of acid acceptor, desirably 2˜20 weight of acid acceptor, 0.1˜10 weight of vulcanization accelerator, desirably 0.3˜2 weight of vulcanization accelerator, 1˜100 weight of filler, desirably 5˜40 weight of filler are used.

Processing of such compound of fluorinated elastomers is that, at first, each said component such as curing agent and so on of above-mentioned weight ratio are added to fluorinated elastomers, then they are mixed and kneaded using for example roller. As such compound of fluorinated elastomers, specifically, followings can be listed up, for example, (x1) compound of fluorinated elastomers comprising vinylidenefluoride elastomers, amine curing agent, acid acceptor, vulcanization accelerator and filler, (x2) compound of fluorinated elastomers comprising vinylidenefluoride elastomers, polyol-curing agent, acid acceptor, vulcanization accelerator and filler, (x3) compound of fluorinated elastomers comprising vinylidenefluoride elastomers, peroxide-curing agent, vulcanization promoter and filler, (x4) compound of fluorinated elastomers comprising tetrafluoroethylene-perfluorovinylether elastomers, polyol-curing agent, acid acceptor, vulcanization accelerator and filler, (x5) compound of fluorinated elastomers comprising tetrafluoroethylene-perfluorovinylether elastomers, triazine-curing agent, acid acceptor, vulcanization accelerator and filler.

Thermoplastic fluorinated elastomers (A2), comprising both of elastomer typed polymer-chain-segment and plastomer typed segment wherein at least one of them is chain-segment including fluorinated elastomer, shows rubber elasticity at room temperature around and shows plastic mobility when it is heated up.

As such thermoplastic fluorinated elastomer, conventional materials can be used widely, for example, elastomers comprising fluorinated rubber component (plastomer typed polymer-chain-segment) and fluororesin component (elastomer typed polymer-chain-segment) can be listed up.

As elastomer typed polymer-chain-segment, followings can be listed up, (1) ternary polymerization elastomers of vinylidenefluoride-hexafluoropropylene or pentafluoropropylene-tetrafluoroethylene, wherein in 100 mol % of copolymer, 40˜90 mol % of vinylidenefluoride unit, 5˜50 mol % of hexafluoropropylene or pentafluoropropylene unit, 0˜35 mol % of tetrafluoroethylene unit are included respectively, or (2) ternary polymerization elastomers of perfluoroalkylvinylether-tetrafluoroethylene-vinylidenefluoride, wherein in 100 mol % of copolymer, 15˜75 mol % of perfluoroalkylvinylether unit, 0˜85 mol % of tetrafluoroethylene unit, 0˜85 mol % of vinylidenefluoride unit are included respectively, and molecular weight of (1) or (2) is approximately 30˜1200 thousand.

As plastomer typed polymer-chain-segment, followings can be listed up, (3) copolymer of vinylidenefluoride-tetrafluoroethylene, wherein in 100 mol % of copolymer, 0˜100 mol % of vinylidenefluoride unit, 0˜100 mol % of tetrafluoroethylene unit are included respectively, or (4) multi-copolymer of ethylene-tetrafluoroethylene-hexafluoropropylene, 3,3,3-trifluoropropylene-1 or perfluoroalkylvinylether, wherein in 100 mol % of copolymer, 40˜60 mol % of ethylene unit, 60˜40 mol % of tetrafluoroethylene unit, 0˜30 mol % of hexafluoropropylene unit are included respectively, and molecular weight of (3) or (4) is approximately 30000˜400 thousand. Concerning thermoplastic fluorinated elastomers, the details are described in Japanese laid open patent S53-3495 (1978), Japanese applied patent S60-109141 (1985).

In a case of such thermoplastic fluorinated elastomer, ratio of elastomer typed polymer-chain-segment and plastomer typed polymer-chain-segment is approximately 40˜95:60˜5 in weight ratio.

Such copolymer of fluororubber and fluororesin, namely, thermoplastic fluorinated elastomers is on sale, for example, Dai-el Thermo (Daikin Ind. Co.Ltd.).

We can make a preliminary mold from the thermoplastic fluorinated elastomers, according to conventional method. We can make it to fill mold of metal having requested pattern with the thermoplastic fluorinated elastomers, heat it and then cool it. In this case, curing agent, filler and so on of above-mentioned may not necessarily be add to said elastomers, but depending on a case, such curing agent as polyol, peroxide, and so on can be added.

Requested cured thermoplastic fluorinated elastomers can be made curing three dimensionally such preliminary mold of the thermoplastic fluorinated elastomers by radioactive ray.

In a case of curing such preliminary mold by radioactive ray, it is exposed generally to 3˜300 K gray of, desirably 70˜200 K gray of radioactive ray. As radioactive ray, X-ray, gamma ray, electron beam, proton beam, deuteron beam, α-ray, β-ray etc. can be used.

To reduce emission of gas from the elastomers due to its high temperature treatment in its applications, above-mentioned bridge constructed compound of fluorinated elastomers (A1) or thermoplastic fluorinated elastomers (A2) is thermally treated for more than 1 hour at 250˜400° C., desirably 8˜24 hours at 260˜270°. However, thermal treatment in excess of above-mentioned range for fluororubber brings thermal resolution of fluororubber or deterioration of it. Furthermore, in a case of thermal treatment under 250° C., volatile ingredient including in the fluororubber can not be emmited r eliminated, then the fluororubber remains as fluororubber emitting much gas in high vacuum environment. In a case of said fluororubber thermally treated in above described, volume of emitted gas per unit surface area after being held 12 hours at normal temperature (25° C.) in vacuum atmosphere of 1*10⁻⁵˜1*10⁻⁸ is less than 1*10⁻⁷ Torr·1/sec·cm², desirably less than 5·10⁻⁸·1 Torr·1/sec˜cm². As emitted gas, for example, hydrocarbon, water, low molecular composition of base polymer can be listed up.

In a case of fluorinated elastomers, the second cure may be performed, also may not be performed, before thermal treatment of above-mentioned hour and temperature. To use for the present invention, said fluorinated elastomers can be performed reduced pressure treatment under 100 Torr, desirably under 1 Torr, before said high temperature thermal treatment or after said high temperature thermal treatment. Such reduced pressure treatment can be performed more than 0.1 hours desirably more than 0.1 hours, at 25˜400° C., desirably 100˜200° C. Over 100 Torr, said reduced pressure treatment is not effective. Further, the pressure of reduced pressure treatment is lower, the hour is shorter and the temperature is lower.

Further, for application in the present invention, said cured fluorinated elastomers may contact with solvent before said high temperature thermal treatment or after said high temperature thermal treatment. To make contact said cured fluorinated elastomers and solvent, cured fluorinated elastomers can be dipped into solvent. Through such contact fluorinated elastomers and solvent, some kind of volatile components being emitted in application under vacuum atmosphere can be took away beforehand, then volume of emitted gas in application under vacuum atmosphere can be reduced.

As solvent, organic solvent, inorganic solvent, mixed solvent can be listed up. As organic solvent, polar solvent such as acetone, methylethylketon (MEK) and alcohol, nonpolar solvent such as benzene and toluene can be listed up. In such organic solvent, polar solvent is desirable. Such polar solvent can easily permeate into the said cured fluorinated elastomers, then component for gas is easily abstracted.

As inorganic solvent, water and so on can be listed up. As mixed solvent, water-acetone mixed solvent, water-alcohol mixed solvent, and so on can be listed up. In such solvent, water not having problem of environmental pollution is desirably used.

As water, pure water is desirable, especially pure water having higher than 10⁵ Ω·cm of resistivity measured at 25° C. is desirable. About contact hour etc. between the solvent and said cured fluorinated elastomers, it changes due to component of said cured fluorinated elastomers, sort and concentration of solvent used, and in a case of using above-mentioned pure water, for example, the cured fluorinated elastomers can be contacted with pure water of higher than 25° C., desirably heated to 95˜100° C., more than 0.1 hours, desirably 0.3˜5 hours.

Through above-mentioned process, fluorinated elastomers from which emission is very low level are realized.

Followings are more specific explanation about an embodiment of fluorinated elastomers which can be used for the present invention, but the present invention is not limited to that example narrowly.

### EXAMPLE 1

The compound of fluorinated elastomers having following constituent is made. Wherein, duality—fluororubber made of vinylidenefluoride and hexafluoropropylene is made (Followings are included in fluororubber 100 mole % vinylidenefluoride unit 77 mole %, hexafluoropropylene 23 mole %. Molecular weight of fluororubber is 100,000.):

Fluororubber—100 weight, magnesium oxide—3 weight, carbon black—30 weight, calcium hydroxide—6 weight, vulcanization accelerator (quaternaryammonium)—1 weight, curing agent (bisphenol A F)—1 weight.

Above-mentioned compound of fluorinated elastomers is put into mold of metal, then the first cure of the compound is performed 10 minutes at 170° C., under pressure of 30 Kgf/cm², Consecutively, high temperature thermal treatment of the compound which is performed the first cure is performed 16 hours, at 250° C., under atmospheric pressure.

Consequently, the thermally treated fluororubber showed that volume of emitted gas per O ring surface area after being held 12 hours at normal temperature in vacuum atmosphere of 1*10⁻⁷˜1*10⁻⁸ was 4.8*10⁻⁸ Torr·1/sec·cm².

### EXAMPLE 2

High temperature thermal treatment of the compound which is the same compound as example 1 and is performed the first cure in the same way as example 1 is performed 16 hours, at 270°0 C., under atmospheric pressure.

Consequently, the thermally treated fluororubber showed that volume of emitted gas per O ring surface area after being held 12 hours at normal temperature in vacuum atmosphere of 1*10^{-7˜1*10}⁻⁸ was 2.3*10⁻⁸ Torr·1/sec·cm².

### COMPARATIVE EXAMPLE 1

A mold was made directly using the compound which is the same compound as example 1 and is performed the first cure in the same way as example 1.

Consequently, the mold showed that volume of emitted gas per O ring surface area after being held 12 hours at normal temperature in vacuum atmosphere of 1*10⁻⁵˜0.1*10⁻⁵ was 0.41*10⁻⁵ Torr·1/sec·cm².

### COMPARATIVE EXAMPLE 2

High temperature thermal treatment of the compound which is the same compound as example 1 and is performed the first cure in the same way as example 1 is performed 24 hours, at 230° C., under atmospheric pressure.

Consequently, the thermally treated fluororubber showed that volume of emitted gas per O ring surface area after being held 12 hours at normal temperature in vacuum atmosphere of 0.1*10⁻⁵˜1*10⁻⁷ was 2.2*10⁻⁷ Torr·1/sec·cm².

It is obvious from above explanation about example 1, example 2, comparative example 1, comparative example 2 that volume of emitted gas of the example 1 and the example 2 are clearly less than volume of emitted gas of the comparative example 1 and the comparative example 2.

Thus example of fluorinated elastomers being able to be used for the present invention has been described in detail. When the elastic projections, side wall, core of reel which construct the holding equipment for optical fiber of the present invention are made of above-mentioned fluorinated elastomers, such holding equipment for optical fiber can show such noticeable effect that work to be done under atmospheric pressure which is attaching optical component such as collimator, filter etc. to the optical fiber, polishing of the terminal surface of the optical fiber becomes easy by using the holding equipment for optical fiber of the present invention held relatively short optical fiber having length of 20 m or shorter as described above, in addition, above-mentioned holding equipment for optical fiber can show such noticeable effect that work to be done in vacuum and high temperature environment such as formation of antireflective layer on the terminal surface of the fiber in a vacuum vaporized deposition device can be done without fear of harm to antireflective layer in its quality due to the emitted gas, consequently, vaporized deposition can be performed by mounting the holding equipment for optical fiber of the present invention holding said optical fiber in the vacuum vaporized deposition device.

The holding equipments for optical fiber made of above-mentioned fluorinated elastomers are especially desirable examples of the present invention which show extremely remarkable effect.

However, the present invention is not narrowly limited to above-mentioned example. Namely, there are many cases of processing for the optical fiber having length of 20 m, for example, 2 m, 3 m, 5 m where the process does not need vacuum environment. There are cases where the fiber should be held in compact size, for example, before vacuum processing, after vacuum processing, in carrying of completed products, in application for automatism. In such cases, as previously described, the conventional process has difficulties due to absent of suitable holding equipment for optical fiber. For such cases, the holding equipments for optical fiber made of said fluorinated elastomers are available, however, there are cases where more inexpensive holding equipment or holding equipment of different nature are desired.

The present invention meets also such request. The holding equipment for optical fiber of the present invention can be made by using silicone elastomers as materials for said elastic parts. By using silicone elastomers, holding equipment for optical fiber of the present invention having said effects explained in said each embodiment of the present invention except application in vacuum environment can be provided.

In addition, metal can be used for components of the holding equipment for optical fiber of the present invention. For example, the construct for reinforcement being inserted to interior of core of reel can be made of stainless steel, furthermore, optical fiber holding unit can be made by using aluminum, titanium alloy, magnesium alloy. Due to use such metals, the holding equipment for optical fiber of the present invention can be applied more widely and life of it becomes longer.

Type of the optical fiber being able to show excellent effect installed into the holding equipment for optical fiber of the present invention are many kinds of optical fiber, for example, buffered fiber having diameter of 0.25 mm about which is needless to say, core fiber, ribbon fiber, and a result of applied them for the holding equipment for optical fiber of the present invention showed excellent effect described above.

As described above, the holding equipment for optical fiber of the present invention can hold the optical fiber having length of 20 m, for example, 2 m, 3 m, 5 m in compact, and can show excellent effect such as easy to handle, easy to wind and unwind, no fear of snapping in processing, stable against fall, keeping required small sized shape with high reliability, furthermore, being able to be used for forming antireflective layer on the terminal surface of the optical fiber in vacuum environment. In addition, due to that plural of the holding equipments do not cling firmly each other when they are piled up under condition of slightly pressed, machining process and/or automated process can be realized by using the holding equipment for optical fiber of the present invention.

### INDUSTRIAL APPLICABILITY

As described above, due to said characteristics, the holding equipment for optical fiber of the present invention can be widely applied to industrial field using optical fiber typically optical communication, for example, can be widely used for said many kind of process, storage, caring of relatively short optical fiber used in optical communication, can be widely used for processing of optical fiber having length of 2 m, 3 m, 5 m, then, can contribute to the progress of said industrial field.

1. A holding equipment for optical fiber, in which optical fiber can be held: wherein the holding equipment for optical fiber comprises at least one holding unit in which optical fiber can be held by being wound, at least one of said holding unit comprises one pair of side walls which are placed in opposition each other and plural elastic projections placed on at least one said side wall.

2. The holding equipment for optical fiber according to claim 1, wherein at least one of said holding unit comprises core of reel on which optical fiber can be wound, said core of reel is placed by connecting with said side wall or closing to said side wall, said projections placed on said at least one side wall of holding unit for optical fiber are placed at locations of said side wall that is positions, hereinafter, to be also referred to as the inner part of side wall, namely, positions which are inner side from a fringe of the side wall of holding unit, that is, closer positions to said core of reel on the side wall, and said projections are formed as elastic projections which stick out from the side wall toward the opposite side wall, and by that at least said one pair of side walls, said elastic projections and said core of reel construct optical fiber holding area in which optical fiber can be held.

3. The holding equipment for optical fiber according to claim 2, wherein shape of fringe of said core of reel of at least one of said holding unit on that optical fiber can be wound is circular shape or ellipsoidal shape or polygonal shape.

4. The holding equipment for optical fiber according to claim 2, wherein shape of major part of at least one said side wall of at least one of said holding unit is flat board state and shape of fringe of said side wall of at least one of said holding unit is circular shape or ellipsoidal shape or polygonal shape.

5. The holding equipment for optical fiber according to claim 2, wherein at least one said side wall, plural projections placed on the wall and core of reel connected to the wall are formed into one-piece.

6. The holding equipment for optical fiber according to claim 2, wherein plural of said projections have such shape that shape is a shape, hereinafter, to be also referred to as slender shape, and have such measure that length of the projection sticking out from the side wall on which the projection is formed is longer than the maximum measure of cross section of the projection, defining the cross section of the projection is that crossing at right angles to the center line of length direction of the projection and the measure of the cross section is measured as a straight line from one end to the opposite end through the center of the cross section.

7. The holding equipment for optical fiber according to claim 6, wherein plural of said projections have a shape like a pole.

8. The holding equipment for optical fiber according to claim 6, wherein plural of said projections have a flat shape.

9. The holding equipment for optical fiber according to claim 6, wherein each of plural of said elastic projections is formed slanted such that a length directional mean central axis of said projection which is a imaginary axis, hereinafter, to be also referred to as a length directional center line, slants toward inner side of said optical fiber holding area as making required angle θ1 with the perpendicular line of said side wall at the place.

10. The holding equipment for optical fiber according to claim 9, wherein all the projections formed for at least one of said holding unit are formed slanted such that each length directional center line slants toward inner side of said optical fiber holding area as making required angle θ1 to the perpendicular line of said side wall at the place.

11. The holding equipment for optical fiber according to claim 9, wherein required angle θ1 is smaller than 10 degree.

12. The holding equipment for optical fiber according to claim 6, wherein said projection which is placed on the side wall of at least one holding unit is formed slanted such that a length directional center line slants toward one direction along the fringe of the side wall as making required angle θ3.

13. The holding equipment for optical fiber according to claim 12, wherein all the projections formed on the side wall of at least one holding unit are formed slanted such that each length directional center line of it slants toward one direction along the fringe of the side wall as making required angle θ3.

14. The holding equipment for optical fiber according to claim 12, wherein said required angle θ3 is smaller than 10 degree.

15. The holding equipment for optical fiber according to claim 6, wherein each of said plural projections is that outside tangent of outline of the projection of radius direction of the side wall on which the projection is placed and inside tangent of outline of the projection of the radius direction of the side wall crosses as making required angle θ2 on the cross section which include the center point of the side wall on which the projection is placed, the center point of the root of the projection and the end point of the center line of the projection, except parts having large alteration for example root around and the end point around of the projection, and the projection is dwindling from root of it to the end point of it.

16. The holding equipment for optical fiber according to claim 6, wherein each of all the projections of at least one said holding unit is that outside tangent of outline of the projection of radius direction of the side wall on which the projection is placed and inside tangent of outline of the projection of the radius direction of the side wall crosses as making required angle θ2 on the cross section which include the center point of the side wall on which the projection is placed, the center of the root of the projection and the tip of the center line of the projection, except parts having large alteration for example root around and the end point around of the projection, and the projection is dwindling from root of it to the end point of it.

17. The holding equipment for optical fiber according to claim 15, wherein the required angle θ2 is smaller than 15 degree.

18. The holding equipment for optical fiber according to claim 6, wherein dimension of the cross section of said elastic projection of at least one holding unit is such that a mean diameter of the projection at the middle part in length direction is 0.4˜2 mm.

19. The holding equipment for optical fiber according to claim 6, wherein each of all said elastic projections of at least one said holding unit is that dimension of the cross section of said elastic projection is such that a mean diameter of the projection at the middle in length direction is 0.4˜2 mm.

20. The holding equipment for optical fiber according to claim 6, wherein shape of the tip of said elastic projection is a part of circle having diameter of 0.2˜1 mm on the cross section of the projection including the center of the side wall on which the projection is placed.

21. The holding equipment for optical fiber according to claim 6, wherein said projection is such projection that diameter of the tip around is smaller than diameter of the root around.

22. The holding equipment for optical fiber according to claim 6, wherein length of at least one said elastic projection is longer than one fourth of space between a pair of side walls which are placed in opposition each other.

23. The holding equipment for optical fiber according to claim 22, wherein length of at least one said elastic projection is longer than one half of space between a pair of said side walls which are placed in opposition each other.

24. The holding equipment for optical fiber according to claim 6, wherein length of at least one said elastic projection is shorter as 0.05˜0.15 mm than space between a pair of side walls which are placed in opposition each other.

25. The holding equipment for optical fiber according to claim 6, wherein at least two of said elastic projections which are placed on at least one side wall is such pair-projection which is a pair of projections that space between the two projections is 0 or narrower than two times of mean diameter of a outer circle which touch and include tightly the projection inside of it.

26. The holding equipment for optical fiber according to claim 6, wherein the center position of each projection not forming the pair-projection and/or the center position of each said pair-projection are placed in equivalent pitch in the direction along the fringe of the side wall on at least one said side wall of at least one said holding unit.

27. The holding equipment for optical fiber according to claim 6, wherein all the elastic projections are formed only on one side wall of a pair of said side walls which are placed in opposition each other.

28. The holding equipment for optical fiber according to claim 6, wherein 24 of said single projections and/or said pair-projections are formed on at least one side wall of at least one holding unit.

29. The holding equipment for optical fiber according to claim 28, wherein each center of two nearest neighbor projections which are two nearest neighbor single projections or two nearest neighbor pair-projections or one single projection and one nearest neighbor pair-projection make the center angle of 15° against the center of said side wall.

30. The holding equipment for optical fiber according to claim 6, wherein said elastic projections are formed on both side walls which are placed in opposition each other, of the side wall, hereinafter, to be also referred to as the first side wall and the side wall, hereinafter, to be also referred to as the second side wall.

31. The holding equipment for optical fiber according to claim 30, wherein at least one pair of said elastic projections which are placed on both side walls are placed at the position which are in opposition each other.

32. The holding equipment for optical fiber according to claim 31, wherein the sum total length of two projections which are placed in opposition each other is longer than one fourth of space between said both side walls.

33. The holding equipment for optical fiber according to claim 31, wherein the sum total length of two projections which are placed in opposition each other is longer than one half of space between said both side walls.

34. The holding equipment for optical fiber according to claim 31, wherein the sum total length of two projections which are placed in opposition each other is shorter as 0.05˜0.15 mm than space between said both side walls.

35. The holding equipment for optical fiber according to claim 30, wherein the projection is not placed at a position of the second side wall that is corresponding position to a position where the projection is placed of the first side wall, and the projection is not placed at a position of the first side wall that is corresponding position to a position where the projection is placed of the second side wall.

36. The holding equipment for optical fiber according to claim 35, wherein said elastic projections which are formed on the first side wall and the second side wall being placed in opposition each other are formed such that the projection on the first side wall and the projection on the second side wall are placed alternately in the direction along the fringe of side wall.

37. The holding equipment for optical fiber according to claim 35, wherein the sum total length of two projections which are placed on the first side wall and the second side wall is longer than one fourth of space between said both side walls.

38. The holding equipment for optical fiber according to claim 35, wherein the sum total length of two projections which are placed on the first side wall and the second side wall is longer than one half of space between said both side walls.

39. The holding equipment for optical fiber according to claim 35, wherein the sum total length of two projections which are placed on the first side wall and the second side wall is shorter as 0.05˜0.15 mm than space between said both side walls.

40. The holding equipment for optical fiber according to claim 35, wherein sum total length of two projections which are one projection of one side wall and the nearest neighbor projection of the other wall is longer as 0.05˜0.24 mm than space between said both side walls.

41. The holding equipment for optical fiber according to claim 35, wherein the center of each projection not forming the pair-projection and/or the center of each said pair-projection are placed in equivalent pitch in the direction along the fringe of the side wall on one said side wall and/or on both said side walls of at least one said holding unit.

42. The holding equipment for optical fiber according to claim 35, wherein 48 of said single projection and/or said pair-projection are formed on one side wall and/or both side wall of at least one said holding unit.

43. The holding equipment for optical fiber according to claim 35, wherein both of each center of two projections which are two nearest neighbor single projections or two nearest neighbor pair-projections or one single projection and one nearest neighbor pair-projection makes the center angle of 7.5° against the center of said side wall.

44. The holding equipment for optical fiber according to claim 6, wherein at least one side wall of said side wall having elastic projections is a side wall, hereinafter, to be also referred to as a side wall comprising projections on both side, comprising plural said elastic projections on one side and the other side of the side wall.

45. The holding equipment for optical fiber according to claim 6, wherein said side wall said plural projections formed on the side wall and the core of reel are formed in one body.

46. The holding equipment for optical fiber according to claim 2, wherein at least one projection of said projections is a projection, hereinafter, to be also referred to as belt styled projection or belt projection, which has such size that size of the projection measured along the fringe of the wall is lager than size of the projection measured toward the radius of the wall.

47. The holding equipment for optical fiber according to claim 46, wherein area of cross section of root around, namely raising up place from the side wall, of said belt styled projection is lager than area of cross section of end portion of it.

48. The holding equipment for optical fiber according to claim 46, wherein plural said belt styled projections are formed on the same side of at least one side wall.

49. The holding equipment for optical fiber according to claim 46, wherein number of said belt styled projections which are formed on the same side of at least one side wall is four.

50. The holding equipment for optical fiber according to claim 46, wherein a belt styled projection, hereinafter, to be also referred to as projection A, and a projection which is not a belt styled projection, hereinafter, to be also referred to as projection B, are formed on the same side of at least one side wall.

51. The holding equipment for optical fiber according to claim 2, wherein said core of reel is formed on one side of said side wall and also said core of reel is formed on the other side of the side wall.

52. The holding equipment for optical fiber according to claim 51, wherein size of said core of reel of one side of said side wall that is measured perpendicular direction to the wall and size of said core of reel of the other side of the side wall that is measured perpendicular direction to the wall are different.

53. The holding equipment for optical fiber according to claim 2, wherein at least one side wall among the side wall having said elastic projections is a side wall having projections on both side of it, that is, a side wall which has plural said projections on one side and the reverse side of the wall respectively.

54. The holding equipment for optical fiber according to claim 53, wherein space between two projections placed on one side of at least one side wall having projections on both side of it and space between two projections placed on the other side of the side wall are different space.

55. The holding equipment for optical fiber according to claim 53, wherein shape and size of projections placed on one side of at least one side wall having projections on both side of it, and shape and size of projections placed on the other side of the side wall are different shape and size.

56. The holding equipment for optical fiber according to claim 53, wherein only projections which are not belt styled projections are placed on one side of at least one side wall having projections on both side of it, and at least two belt styled projections are placed on the other side of the side wall.

57. The holding equipment for optical fiber according to claim 56, wherein at least one side wall having projections on both side of it has at least two belt styled projections near to fringe of the side wall.

58. The holding equipment for optical fiber according to claim 53, wherein projections which are not belt styled projections are placed on one side of at least one side wall having projections on both side of it, and four of belt styled projections are placed near to fringe of the other side of the side wall and, in addition, at least two pair of said pair-projections are placed at the position which is nearer position to core of reel than the position at which the belt styled projections are placed.

59. The holding equipment for optical fiber according to claim 53, wherein distance from fringe of at least one side wall which is a side wall having projections on both side of it to the outside surface of the core of reel, that is width of the side wall is different at one side of that side wall and the other side of that side wall.

60. The holding equipment for optical fiber according to claim 53, wherein width of side wall having belt styled projections near to fringe of the wall which is one side of the side wall having projections on both side of it, hereinafter, to be also referred to as the second width of side wall is larger than width of side wall having projections which are not belt styled projections near to fringe of the wall which is the other side of the side wall having projections on both side of it, hereinafter, to be also referred to as the first width of side wall.

61. The holding equipment for optical fiber according to claim 2, wherein said side wall has four of ditches or slits, namely cut parts.

62. The holding equipment for optical fiber according to claim 61, wherein said cut part reaches to position of the core of reel on the side wall having the projections.

63. The holding equipment for optical fiber according to claim 1, wherein at least one pair of said side walls and projections formed on said side wall are made of fluorinated elastomer.

64. The holding equipment for optical fiber according to claim 63, wherein hardness of the fluorinated elastomer which forms said holding equipment for optical fiber is 70˜90 in Shore hardness.

65. The holding equipment for optical fiber according to claim 64, wherein hardness of the fluorinated elastomer which forms said holding equipment for optical fiber is 75˜85 in Shore hardness.

66. The holding equipment for optical fiber according to claim 63, wherein said fluorinated elastomer is vinylidenefluoride elastomer or tetrafluoroethylene-perfluorovinylether elastomer.

67. The holding equipment for optical fiber according to claim 66, wherein contents of fluorine of said fluorinated elastomer is 65˜70%.

68. The holding equipment for optical fiber according to claim 66, wherein said fluorinated elastomer is thermally treated for more than 1 hour at 250˜400° C. on the manufacturing process.

69. The holding equipment for optical fiber according to claim 68, wherein said fluorinated elastomer is thermally treated for 8˜24 hours at 260˜270° C. on the manufacturing process.

70. The holding equipment for optical fiber according to claim 66, wherein said holding equipment for optical fiber is a holding equipment which was post-vulcanized it 204˜260° C. after formed holding equipment for optical fiber.

71. The holding equipment for optical fiber according to claim 2, wherein said core of reel, said at least one pair of side walls and projections formed on said side wall of at least one holding unit are made of fluorinated elastomer.

72. The holding equipment for optical fiber according to claim 71, wherein hardness of the fluorinated elastomer which forms said holding equipment for optical fiber is 70˜90 in Shore hardness.

73. The holding equipment for optical fiber according to claim 72, wherein hardness of the fluorinated elastomer which forms said holding equipment for optical fiber is 75˜85 in Shore hardness.

74. The holding equipment for optical fiber according to claim 71, wherein said fluorinated elastomer is vinylidenefluoride elastomer or tetrafluoroethylene-perfluorovinylether elastomer.

75. The holding equipment for optical fiber according to claim 74, wherein contents of fluorine of said fluorinated elastomer is 65˜70%.

76. The holding equipment for optical fiber according to claim 74, wherein said fluorinated elastomer is thermally treated for more than 1 hour at 250-400° C. on the manufacturing process.

77. The holding equipment for optical fiber according to claim 76, wherein said fluorinated elastomer is thermally treated for 8˜24 hours at 260˜270° C. on the manufacturing process.

78. The holding equipment for optical fiber according to claim 74, wherein said holding equipment for optical fiber is a holding equipment which was post-vulcanized at 204˜260° C. after formed holding equipment for optical fiber.

79. The holding equipment for optical fiber according to claim 2, wherein said core of reel, said at least one pair of side walls and projections formed on said side wall of at least one holding unit are made of silicone elastomer.

80. The holding equipment for optical fiber according to claim 79, wherein said silicone elastomer is colored, opaque against a visible ray.

81. The holding equipment for optical fiber according to claim 80, wherein color of said silicone elastomer can be used for distinction of said holding equipment for optical fiber.

82. The holding equipment for optical fiber according to claim 2, wherein the holding equipment for optical fiber has at least two holding unit for optical fiber of the first holding unit and the second holding unit, and the first holding unit has said elastic projections on one said side wall of at least one pair of side walls which are placed in opposition each other or both said side wall of at least one pair of side walls which are placed in opposition each other.

83. The holding equipment for optical fiber according to claim 82, wherein the second holding unit has said elastic projections on one said side wall of at least one pair of side walls which are placed in opposition each other or both said side wall of at least one pair of side walls which are placed in opposition each other.

84. The holding equipment for optical fiber according to claim 82, wherein the second holding unit has at least one pair of side walls which have not said elastic projections.

85. The holding equipment for optical fiber according to claim 82, wherein all of the side wall, the core of reel and the elastic projections of the first holding unit and the second holding unit are made of elastic materials.

86. The holding equipment for optical fiber according to claim 82, wherein the first holding unit and the second holding unit are composed being able to be connected in one body by using unit-connection-part.

87. The holding equipment for optical fiber according to claim 86, wherein said unit-connection-part is a part which connect said the first holding unit and the second holding unit in one body by inserting the part into a hole or a cavity formed on the first holding unit and into a hole or a cavity formed on the second holding unit to hold said the first holding unit and the second holding unit.

88. The holding equipment for optical fiber according to claim 82, wherein said the first holding unit and the second holding unit are made of elastic material into one body by using one-piece molding.

89. The holding equipment for optical fiber according to claim 82, wherein said the first holding unit and the second holding unit are made of different materials.

90. The holding equipment for optical fiber according to claim 89, wherein the materials which construct the second holding unit are the materials having characteristics of a rigid body as a holding unit for optical fiber.

91. The holding equipment for optical fiber according to claim 82, wherein a connection-part by which said the first holding unit can be connected with said the second holding unit in a condition of removable and re-connectable is formed in one body with the second holding unit as a extended part from the second holding unit.

93. The holding equipment for optical fiber according to claim 82, wherein an attaching part in style of concave part or convex part that can combine with at least one of the first and the second holding unit is formed as a part of the connection-part, and a combining part which is concave part or convex part is formed on the holding unit which is connected to the attaching part.

94. The holding equipment for optical fiber according to claim 82, wherein one side wall of a pair of side walls which are placed in opposition each other of the second holding unit is the back side of the side wall which is one of a pair of side walls of the first holding unit.

95. The holding equipment for optical fiber according to claim 82, wherein said the second holding unit has a pair of side walls which are placed in opposition each other and different from that of the first holding unit.

96. The holding equipment for optical fiber according to claim 82, wherein said holding equipment for optical fiber has the third holding unit for optical fiber in addition to the first holding unit and the second holding unit.

97. The holding equipment for optical fiber according to claim 96, wherein the third holding unit is formed such structure as capable being connected with the first holding unit or the second holding unit into one body.

98. The holding equipment for optical fiber according to claim 96, wherein the third holding unit has a pair of side walls which are placed in opposition each other, and at least one of the pair of side walls is a side wall having said projections.

99. The holding equipment for optical fiber according to claim 82, wherein at least one of said side walls is a side wall formed as being able to be fit between two side walls after formed independently of the other component being comprised in said holding equipment for optical fiber and to construct two holding unit for optical fiber.

100. The holding equipment for optical fiber according to claim 82, wherein at least one of said side walls is a side wall having said projections on its both side.

101. The holding equipment for optical fiber according to claim 82, wherein at least two of said optical fiber holding area of each of at least two of said holding unit have different depth of the holding unit respectively.

102. The holding equipment for optical fiber according to claim 82, wherein at least one of said side walls constructing boundary of said two holding unit is a side wall having said ditches or slits.

103. The holding equipment for optical fiber according to claim 2, wherein size of projection of the fringe of said side wall is within a circle having 10 cm in diameter.

104. The holding equipment for optical fiber according to claim 2, wherein thickness of said holding equipment for optical fiber is thinner than 3 mm.

105. A holding equipment for optical fiber into which the optical fiber having length within 5 m can be wound; wherein the holding equipment for optical fiber comprises optical fiber holding area, where-into the optical fiber can be hold wound on a core of reel, comprising, at least, a core of reel having shape of its fringe of circle or ellipse or polygon on which optical fiber can be wound, at least one pair of side walls placed in opposition each other, connected with said core of reel or combined to said core of reel, having shape of fringe of circle or ellipse or polygon and having shape of flat board, elastic projections which are formed at place near the fringe and inner of the fringe on the side wall stick out from the wall toward the opposite side wall, and hollow formed at the core of reel and the side walls.

106. A holding equipment for optical fiber in which the optical fiber can be held by wound; wherein the holding equipment for optical fiber is made of cured fluorinated elastomer.

107. The holding equipment for optical fiber according to claim 106, wherein hardness of said fluorinated elastomer is 70˜90 in Shore hardness.

108. The holding equipment for optical fiber according to claim 107, wherein hardness of said fluorinated elastomer is 76˜86 in Shore hardness.

109. The holding equipment for optical fiber according to claim 106, wherein said fluorinated elastomer is vinylidenefluoride elastomer or tetrafluoroethylene-perfluorovinylether elastomer.

110. The holding equipment for optical fiber according to claim 109, wherein said fluorinated elastomer contains 65˜70% of fluorine.

111. The holding equipment for optical fiber according to claim 109, wherein said fluorinated elastomer is thermally treated for more than 1 hour at 250˜400° C. on the manufacturing process.

112. The holding equipment for optical fiber according to claim 111, wherein said fluorinated elastomer is thermally treated for 8˜24 hours at 260˜270° C. on the manufacturing process.

113. The holding equipment for optical fiber according to claim 106, wherein said holding equipment is a holding equipment which was post-cured at 204˜260° C. after formed holding equipment.
